(19) United States
(12) Patent Application Publication
(10) Pub. No.: US 2024/0375084 A1
(43) Pub. Date: Nov. 14, 2024

(54) SUPRAMOLECULAR GOLD STRIPPING FROM ACTIVATED CARBON USING ALPHA-CYCLODEXTRIN

(71) Applicant: Northwestern University, Evanston, IL (US)

(72) Inventors: James Fraser Stoddart, Evanston, IL (US); Wenqi Liu, Evanston, IL (US)

(21) Appl. No.: 18/258,431

(22) PCT Filed: Dec. 21, 2021
(86) PCT No.: PCT/US2021/073050

§ 371 Date: Jun. 20, 2023

Related U.S. Application Data
(60) Provisional application No. 63/128,459, filed on Dec. 21, 2020.

(51) Int. Cl. B01J 20/34; B01J 20/20; C22B 3/20; C22B 11/00; C25C 1/20

(52) U.S. Cl. CPC B01J 20/3475; B01J 20/20; B01J 20/3416; C22B 3/205; C22B 11/04; C25C 1/20

(57) ABSTRACT

Disclosed herein are compositions, methods, and systems for supramolecular gold stripping where the composition comprises a surface-bound, linear gold anion and a solution comprising a molecular receptor that facilitates the transfer of the linear gold anion from the surface to the solution.

### CROSS-REFERENCE TO RELATED APPLICATIONS

This application represents the National Stage entry of PCT/US2021/073050 filed on Dec. 21, 2021, which claims benefit of priority to U.S. Provisional Application Ser. No. 63/128,459, filed Dec. 21, 2020, the contents of each are incorporated by reference in their entireties.

### STATEMENT REGARDING FEDERALLY FUNDED RESEARCH

This invention was made with government support under Grant No. ER18-1026 awarded by the Department of Defense. The government has certain rights in the invention.

### BACKGROUND

Gold, as a precious metal, is used,^{1,2} not only in jewelry and currency, but also as an increasingly indispensable element in chemical synthesis,³⁻¹⁰ nanotechnology,¹¹⁻¹⁴ modern electronics,^{15,16} and medicine.¹⁷⁻¹⁹ One of the most commercially successful processes¹ for gold mining from ores is heap leaching, where alkaline cyanide lixiviants are used to solubilize gold as its dicyanoaurate, Au(CN)₂⁻. Activated carbon is introduced in order to separate the dissolved Au(CN)₂⁻ from the leached pulps, a technology known^{25,26} as carbon-in-pulp. The Au(CN)₂⁻ is stripped subsequently from the activated carbon, producing a concentrated solution for the final gold recovery by so-called electrowinning¹. In order to strip the Au(CN)₂⁻ from the activated carbon, harsh conditions,²⁷⁻³⁰ including high temperatures (95-140° C.), high pressures (70-400 kPar), and concentrated cyanide and hydroxide solution are required. As a result, there exists a need for improved gold stripping processes that can be performed under mild conditions using nontoxic reagents.

### SUMMARY OF THE INVENTION

Disclosed herein are compositions, methods, and systems for supramolecular gold stripping. One aspect of the technology is a composition comprising a surface-bound, linear gold anion and a solution, the solution comprising a molecular receptor.

Another aspect of the technology provides for methods for gold stripping. The method may comprise contacting a surface-bound, linear gold anion with a solution comprising a molecular receptor under conditions sufficient for transferring the linear gold anion from the surface into the solution. In some embodiments, the surface-bound linear gold anion is contacted with the solution in the presence of a contaminant and the linear gold-anion is selectively transferred into solution. The method may further comprise recovering the gold from the solution. In some embodiments, the linear gold anion is transferred from the surface into the solution at a temperature between about 10° C. and about 40° C.

Another aspect of the technology provides for an electrolytic system for recovering gold from solution. The system may comprise an electrode and an electrolyte comprising the molecular receptor and a linear gold anion.

In some embodiments of the compositions, methods, and systems described herein, the molecular receptor is α-cyclodextrin (α-CD). In some embodiments of the compositions, methods, and systems described herein, the linear gold anion is Au(CN)₂⁻. In some embodiments of the compositions, methods, and systems described herein, the surface is the surface of activated carbon. In some embodiments of the compositions, methods, and systems described herein, the contaminant anion is Ag(CN)₂⁻.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

FIG. 1 shows space-filling (a) and tubular (b) representations of the solid-state superstructures of Au(CN)₂⁻⊂α-CD obtained from single-crystal X-ray diffraction studies. The inward-facing H-3, H-5 and H-6 protons of α-CD are directed toward the Au(CN)₂⁻ anion, establishing multiple [C—H . . . π] and [C—H . . . Anion] interactions that stabilize the adduct. (c) Tubular and space-filling representations of two types of K⁺ ions, forming seven [K⁺ . . . O] coordinative bonds with glucose residues and two water molecules with a capped trigonal prismatic coordination geometry. The K⁺ ions are located on both the primary and secondary faces of α-CD. Each K⁺ ion connects three α-CDs together. (d) Tubular (α-CD) and space-filling (KAu(CN)₂) representations of the crystal packing between Au(CN)₂⁻ anions and α-CDs, showing the positions of K⁺ cations and Au(CN)₂⁻ anions as well as the relative dispositions of the α-CD tori; (e) Structural formula of α-CD with numerical labels; (f) a tubular representation of α-CD; (g) a space-filling representation of Au(CN)₂⁻; (h) a graphical illustration of gold stripping from the surface of activated carbon into aqueous solution using α-CD.

FIG. 2 illustrates space-filling (a) and tubular (b) representations of the solid-state superstructures of Au(CN)₂⁻⊂(α-CD)₂ obtained from single-crystal X-ray diffraction studies. The inward-facing H-5 and H-6 protons of α-CD are directed toward the Au(CN)₂⁻ anion, establishing multiple [C—H . . . π] and [C—H . . . Anion] interactions that stabilize the adduct. (c) Tubular representations of two EtOH molecules associated with the Au(CN)₂⁻ anion in a space-filling representation. (d) Tubular and space-filling representations of a K⁺ ion, forming seven [K⁺ . . . O] coordinative bonds with glucose residues with a capped trigonal prismatic coordination geometry. The K⁺ ions are only located at the secondary faces of α-CDs. Each K⁺ ion connects four α-CDs together. (e) Tubular (α-CD) and space-filling (KAu(CN)₂) representations of the crystal packing between Au(CN)₂⁻ anions and α-CDs, showing the position of K⁺ cations and Au(CN)₂⁻ anions as well as the relative disposition of the α-CD tori.

FIG. 3 shows (a) ¹H NMR (600 MHz, D₂O, 25° C.) spectra of α-CD (5 mM) titrated with KAu(CN)₂. Numerical labels from the protons are shown on the structural formula in FIG. 1 (e). (b) Changes in chemical shift of H-3 caused by addition of KAu(CN)₂. The trace represents curve fitting using a 1:1 receptor-substrate binding model. (c) Calculated changes in mole fractions for α-CD (decending trace) and Au(CN)₂⁻⊂α-CD (ascending trace) in D₂O as a function of the substrate-receptor mole ratio, suggesting a 1:1 binding stoichiometry.

FIG. 4 shows ITC Profiles for the titration of KAu(CN)₂ (0.5 mM, (a) and (b)) and KAg(CN)₂ (0.5 mM, (c) and (d)) with α-CD at 25° C. in H₂O. The red solid line represents the best-fitting curve obtained assuming a 1:1 receptor-substrate binding model.

FIG. 5 shows histograms showing the average concentrations of metals stripped from the surface of activated carbon by cyclodextrins. Effect of the concentrations of (a) α-CD and (b) γ-CD on the stripping of Au. (c) Effect of the concentrations of α-CD on the stripping of Ag, and (d) effect of the concentrations of α-CD on selective stripping of Au from a mixture of Au and Ag loaded on the surface of activated carbon. Au=KAu(CN)₂, Ag=KAg(CN)₂.

FIG. 6 shows labeling for Au(CN)₂⁻ and α-CD in the solid-state superstructure of KAu(CN)₂⊂α-CD.

FIG. 7 shows labeling for Au(CN)₂⁻ and α-cyclodextrin in the solid-state superstructure of KAu(CN)₂⊂(α-CD)₂. The top α-CD is labeled as A and the bottom α-CD is labeled as B.

FIG. 8 shows labeling for Ag(CN)₂⁻ and α-cyclodextrin in the solid-state superstructure of KAg(CN)₂⊂(α-CD)₂. The top α-CD is labeled as A and the bottom α-CD is labeled as B.

FIG. 9 shows (a) first view and (b) second view ball-and-stick representations showing the nearest neighbors of the (1:1) crystal around a central cyclodextrin, which contains a gold cyanide. Each α-CD and K⁺ is given an alphabetic label and the binding energies between the selected species are presented in Table 7.

FIG. 10 shows ¹H NMR Spectra (600 MHz, D₂O, 25° C.) of α-CD (0.5 mM) titrated with KAu(CN)₂.

FIG. 11 shows (a) titration isotherm created by monitoring changes in the chemical shift of H-3 for α-CD (0.5 mM) caused by the addition of KAu(CN)₂ at 25° C. Red lines are curve fitting using a 1:1 receptor-substrate binding model. (b) Calculated changes of mole fractions for α-CD and Au(CN)₂⁻⊂α-CD over the substrate-receptor mole ratio.

FIG. 12 shows ¹H NMR Spectra (600 MHz, D₂O, 25° C.) of β-CD (5 mM) titrated with KAu(CN)₂.

FIG. 13 shows (a) titration isotherm created by monitoring changes in the chemical shift of H-3 for β-CD (5 mM) caused by the addition of KAu(CN)₂ at 25° C. Red lines are curve fitting using a 1:1 receptor-substrate binding model. (b) Calculated changes of mole fractions for β-CD and Au(CN)₂⁻⊂β-CD over the substrate-receptor mole ratio.

FIG. 14 shows (a) titration isotherm created by monitoring changes in the chemical shift of H-3 for β-CD (5 mM) caused by the addition of KAu(CN)₂ at 25° C. Red lines are curve fitting using a 1:2 receptor-substrate binding model. (b) Calculated changes of mole fractions for β-CD, Au(CN)₂⁻⊂β-CD and 2Au(CN)₂⁻⊂β-CD over the substrate-receptor mole ratio.

FIG. 15 shows ¹H NMR Spectra (600 MHz, D₂O, 25° C.) of γ-CD (5 mM) titrated with KAu(CN)₂.

FIG. 16 illustrates (a) titration isotherm created by monitoring changes in the chemical shift of H-3 for γ-CD (5 mM) caused by the addition of KAu(CN)₂ at 25° C. Red lines are curve fitting using a 1:1 receptor-substrate binding model. (b) Calculated changes of mole fractions for γ-CD and Au(CN)₂⁻⊂γ-CD over the substrate-receptor mole ratio.

FIG. 17 illustrates (a) titration isotherm created by monitoring changes in the chemical shift of H-3 for γ-CD (5 mM) caused by the addition of KAu(CN)₂ at 25° C. Red lines are curve fitting using a 1:2 receptor-substrate binding model. (b) Calculated changes of mole fractions for γ-CD, Au(CN)₂⁻⊂γ-CD and 2Au(CN)₂⁻⊂γ-CD over the substrate receptor mole ratio.

FIGS. 18A-18C. (FIG. 18A) ITC profile between KAu(CN)₂ (500 mM, in the syringe) and β-CD (5 mM, in the cell) at 25° C. in H₂O. (FIG. 18B) Nonlinear fitting of enthalpy using 1:1 receptor-substrate binding model. (FIG. 18C) Nonlinear fitting of enthalpy using a 1:2 receptor-substrate binding model.

FIGS. 19A-19C. (FIG. 19A) ITC profile between KAu(CN)₂ (500 mM, in the syringe) and γ-CD (5 mM, in the cell) at 25° C. in H₂O. (FIG. 19B) Nonlinear fitting of enthalpy using 1:1 receptor-substrate binding model. (FIG. 19C) Nonlinear fitting of enthalpy using a 1:2 receptor-substrate binding model.

FIG. 20. illustrates six glucose subunits joined by α-(1,4) glycosidic bonds forming the shape of a tapered cylinder.

### DETAILED DESCRIPTION OF THE INVENTION

Disclosed herein are gold stripping methods and compositions produced therefrom. The present technology provides for a cost-effective and energy-saving method of removing linear gold anion, such as Au(CN)₂⁻, bound to the surface of activated carbon, with an aqueous solution of environmentally benign cyclodextrin. The high binding affinity between the linear gold anion and cyclodextrin in solution enables effective molecular recognition of linear gold anion at room temperature. The gold anion containing composition obtained from performing the method can be processed subsequently to enable gold recovery by using common technologies in industry, such as electrolysis.

As demonstrated in the Examples, the binding affinity between the linear gold anion Au(CN)₂⁻ and α-cyclodextrin in aqueous solutions at room temperature can be as high as 8.1×10⁴ M⁻¹. These results demonstrate that this molecular recognition process between α-cyclodextrin and Au(CN)₂⁻ can be applied to the stripping of gold from the surface of activated carbon under mild conditions using readily available α-cyclodextrins, avoiding the traditional methods used in gold-mining protocol that employ harsh conditions and toxic chemicals. Furthermore, the Examples also demonstrate that the higher binding affinity of Au(CN)₂⁻ than Ag(CN)₂⁻ towards α-cyclodextrin can be utilized to realize selective stripping for Au(CN)₂⁻ in the presence of Ag(CN)₂⁻.

One aspect of the technology is a composition comprising a surface-bound, linear gold anion and a solution. The term “surface-bound” refers to molecules that are capable of being attached non-covalently to the surface of various materials. In some embodiments, the surface is the surface of activated carbon. The term “activated carbon” refers to an adsorbent derived from carbonaceous raw material, in which thermal or chemical means have been used to remove most of the volatile non-carbon constituents and a portion of the original carbon content, yielding a structure with high surface area. Activated carbon is a porous material exhibiting amphoteric characteristics and is usually used for adsorption of organic and inorganic compounds.

The term “linear gold anion” refers to gold-containing anions with linear geometries. The term “linear” refers to the molecular geometry around the central gold atom that is bonded to two other atoms is placed at a bond angle of approximately 180°. In some embodiments, the linear gold anion is Au(CN)²⁻. The counter cations of the linear gold anions include alkaline cations such as Li⁺, Na⁺, K⁺, Rb⁺, and Cs⁺. In some embodiments, the counter cation is K⁺.

In some embodiments, the solution comprises a molecular receptor. The term “molecular receptor” refers to host molecules that contain a binding site or a cavity for a smaller guest molecule or an ion to bind covalently or non-covalently. In some embodiments, the molecular receptor is cyclodextrin. The term “cyclodextrin” refers to any of the known cyclodextrins such as unsubstituted cyclodextrins containing from six to twelve glucose units, especially, alphα-cyclodextrin, betα-cyclodextrin, gammα-cyclodextrin and/or their derivatives and/or mixtures thereof. The alphα-cyclodextrin consists of six glucose units, the betα-cyclodextrin consists of seven glucose units, and the gammα-cyclodextrin consists of eight glucose units arranged in donut-shaped rings. The specific coupling and conformation of the glucose units give the cyclodextrins rigid, conical molecular structures with hollow interiors of specific volumes. The “lining” of each internal cavity is formed by hydrogen atoms and glycosidic bridging oxygen atoms; therefore, this surface is fairly hydrophobic. The unique shape and physical chemical properties of the cavity enable the cyclodextrin molecules to absorb inorganic or organic molecules or parts of inorganic or organic molecules which can fit into the cavity.

In some embodiments, the molecular receptor is cyclodextrin derivatives or modified cyclodextrins. The derivatives of cyclodextrin consist mainly of molecules wherein some of the OH groups are converted to OR groups. The cyclodextrin derivatives can, for example, have one or more additional moieties that provide additional functionality, such as desirable solubility behavior and affinity characteristics. Examples of suitable cyclodextrin derivative materials include methylated cyclodextrins (e.g., RAMEB, randomly methylated betα-cyclodextrins), hydroxyalkylated cyclodextrins (e.g., hydroxypropyl-cyclodextrin and hydroxypropyl-gammα-cyclodextrin), acetylated cyclodextrins (e.g., acetyl-gammα-cyclodextrin), reactive cyclodextrins (e.g., chlorotriazinyl-CD), branched cyclodextrins (e.g., glucosyl-betα-cyclodextrin and maltosyl-cyclodextrin), sulfobutyl-cyclodextrin, and sulfated cyclodextrins.

Cyclodextrin derivatives are also disclosed in U.S. Pat. No. 6,881,712 and include, e.g., cyclodextrin derivatives with short chain alkyl groups, such as methylated cyclodextrins and ethylated cyclodextrins, wherein R is a methyl or an ethyl group; those with hydroxyalkyl substituted groups, such as hydroxypropyl cyclodextrins and/or hydroxyethyl cyclodextrins, wherein R is a —CH₂—CH(OH)—CH₃ or a XH₂CH₂—OH group; branched cyclodextrins such as maltose-bonded cyclodextrins; cationic cyclodextrins such as those containing 2-hydroxy-3-(dimethylamino)propyl ether, wherein R is CH₂—CH(OH)—CH₂—N(CH₃)₂ which is cationic at low pH; quaternary ammonium, e.g., 2-hydroxy-3-(trimethylammonio)propyl ether chloride groups, wherein R is CH₂—CH(OH)CH₂N⁺(CH₃)₃Cl⁻; anionic cyclodextrins such as carboxymethyl cyclodextrins, cyclodextrin sulfates, and cyclodextrin succinylates; amphoteric cyclodextrins such as carboxymethyl/quaternary ammonium cyclodextrins; cyclodextrins wherein at least one glucopyranose unit has a 3-6-anhydro-cyclomalto structure, e.g., the mono-3-6-anhydrocyclodextrins, as disclosed in “Optimal Performances with Minimal Chemical Modification of Cyclodextrins”, F. Diedaini-Pilard and B. Perly, The 7th International Cyclodextrin Symposium Abstracts, April 1994, p. 49 said references being incorporated herein by reference; and mixtures thereof. Other cyclodextrin derivatives are disclosed in U.S. Pat. No. 3,426,011, Parmerter et al., issued Feb. 4, 1969; U.S. Pat. Nos. 3,453,257; 3,453,258; 3,453,259; and 3,453,260, all in the names of Parmerter et al., and all issued Jul. 1, 1969; U.S. Pat. No. 3,459,731, Gramera et al., issued Aug. 5, 1969; U.S. Pat. No. 3,553,191, Parmerter et al., issued Jan. 5, 1971; U.S. Pat. No. 3,565,887, Parmerter et al., issued Feb. 23, 1971; U.S. Pat. No. 4,535,152, Szejtli et al., issued Aug. 13, 1985; U.S. Pat. No. 4,616,008, Hirai et al., issued Oct. 7, 1986; U.S. Pat. No. 4,678,598, Ogino et al., issued Jul. 7, 1987; U.S. Pat. No. 4,638,058, Brandt et al., issued Jan. 20, 1987; and U.S. Pat. No. 4,746,734, Tsuchiyama et al., issued May 24, 1988; all of said patents being incorporated herein by reference.

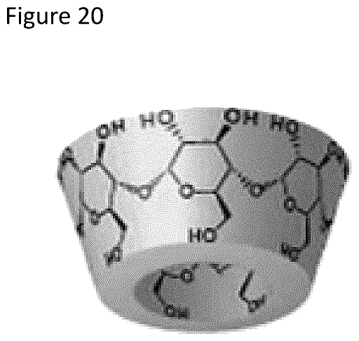

In some embodiments, the molecular receptor is α-cyclodextrin. As used herein, the term “α-cyclodextrin” refers to a cyclic oligosaccharide consisting of six glucose subunits joined by α-(1,4) glycosidic bonds forming the shape of a tapered cylinder as shown in FIG. 20. Alphα-cyclodextrin has a molecular structure of:

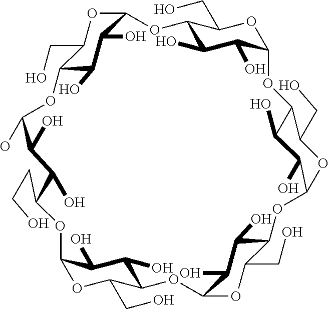 [SMILES: OCC[C@H]1O[C@H]2OC(CO)[C@@H](O[C@H]3OC(CO)[C@@H](OC4OC(CO)C(O[C@H]5OC(CO)[C@@H](O[C@H]6OC(CO)[C@@H](O[C@@H](O)[C@@H](O)[C@H]1O)[C@H](O)[C@H]6O)[C@H](O)[C@H]5O)[C@H](O)[C@H]4O)[C@H](O)[C@H]3O)[C@H](O)[C@H]2O]

In some embodiments, the composition comprises an adduct formed from the molecular receptor and the linear gold anion. As used herein, an “adduct” is a new chemical species AB, each molecular entity of which is formed by direct combination of two separate molecular entities A and B in such a way that there is change in connectivity, but no loss, of atoms within the moieties A and B. Stoichiometries other than 1:1 are also possible, such as 2:1, 3:1, 4:1 and so forth. In some embodiments, the adduct is formed from a linear gold anion non-covalently bound to the cavity of α-cyclodextrin.

The solution is selected to allow for the transfer of the linear gold anion from the surface into solution. In some embodiments, the solution is an aqueous solution.

The concentration of molecular receptor may be selected by those of skill in the art based on several different factors, such as the amount of surface-bound gold to be transferred into solution. Other factors may include, without limitation, the solvent present, the counterions present, the presence and/or amount of contaminants present, the temperature at which transferring step is performed, whether the transferring step is performed in a single or multiple stages, whether the transferring step is performed in a batch or continuous process, and the like. Generally, higher concentrations of the molecular receptor allow for more gold to be transferred into solution. In some embodiments, the solution comprises the molecular receptor at a concentration of 1-10 w/v %. In some embodiments, the solution comprises the molecular receptor at a concentration of at least greater than 1 w/v %, at least 1.5 w/v %, at least 2 w/v %, at least 2.5 w/v %, at least 3 w/v %, at least 3.5 w/v %, at least 4 w/v %, at least 4.5 w/v %, at least 5 w/v %, at least 5.5 w/v %, at least 6 w/v %, at least 6.5 w/v %, at least 7 w/v %, at least 7.5 w/v %, at least 8 w/v %, at least 8.5 w/v %, at least 9 w/v %, or at least 9.5 w/v %.

Another aspect of the technology is to provide a method for gold stripping. The method comprises contacting a surface-bound, linear gold anion as described herein with a solution comprising a molecular receptor as described herein under conditions sufficient for transferring the linear gold anion from the surface into the solution. The conditions may generally refer to the chemical environment or processing conditions.

Chemical environment may refer to the amount of surface-bound gold, the concentration of the molecular receptor, the amount and/or type of surface onto which the gold is bound, the solvent, the presence or amount of contaminants, and the like.

Processing conditions may refer to the temperature at which the temperature at which the transferring step is performed, the pressure at which the transferring is being performed, the volumes being processed, whether the transferring step is performed in a single or multiple stages, whether the transferring step is performed in a batch or continuous process, and the like.

An advantage of the present technology is that the transferring step may be performed without the need for harsh conditions, high temperatures, high pressures, or concentrated cyanide or hydroxide solutions.

The transferring step may be performed at moderate temperatures. Moderate temperatures refers to temperatures between 0° C. and 50° C. In some embodiments, the transferring occurs at a temperature between about 10° C. and about 40° C. In some embodiments, the linear gold anion is transferred from the surface into the solution at a temperature between about 15° C. and about 35° C., between about 20° C. and about 30° C., or between about 23° C. and about 27° C.

Another aspect of the technology is to provide a method for selective gold stripping from a surface. The method comprises contacting a composition comprising a surface-bound, linear gold anion and an anionic contaminant with a solution comprising a molecular receptor under conditions sufficient for selectively transferring the linear gold anion from the surface into the solution. “Selectively transferring the linear gold anion” refers to a selectivity for the linear gold anion over the contaminant of 10:1 or more. In some embodiments, the selectivity for the linear gold anion is greater than 15:1, 20:1, 25:1, or 30:1. Thus the methods disclosed herein allow for the recovery of gold where contaminants may be present in the source of gold or that result in the course of the processing or recovery of gold.

The contaminant may be a linear metal anion. In some embodiments, the contaminant and the linear gold anion differ by the substitution of the gold atom with another metal. Accordingly, the linear gold anion and contaminant may comprise the same ligands surrounding a central metal atom with substantially the same orientation. In some embodiments, the linear gold anion is Au(CN)₂⁻ and the contaminant is Ag(CN)₂⁻.

In some embodiments, the contaminant is bound to the surface of activated carbon. In some embodiments, the contaminant is bound to the same surface on which the linear gold anion is bound. In some embodiments, the contaminant is bound to a different surface than which the linear gold anion is bound.

In some embodiments, the method further comprises recovering gold from the solution. In some embodiments, the gold is recovered electrolytically. Electrolytic processes of recovering gold from solution have been described, e.g., in Nehl et al. “Selective electrowinning of silver and gold from cyanide process solutions.” United States: N. p., 1993.

Electrowinning, also called electroextraction, is the electrodeposition of metals that have been put in solution. Electrowinning uses electroplating purification of metals. In electrowinning, an electrical current is passed from an inert anode (oxidation) through a solution containing the dissolved metal ions so that the metal is recovered as it is deposited in an electroplating process onto the cathode (reduction). The metal ions migrate through the electrolyte towards the cathode where the pure metal is deposited.

Another aspect of the technology is to provide an electrolytic system. The electrolytic system comprises an electrode and an electrolyte comprising a molecular receptor and a linear gold anion. The electrode and potential applied to the electrode should be selected to allow for the deposition of the gold from solution. In some embodiment, the electrolyte comprises the compositions as described herein.

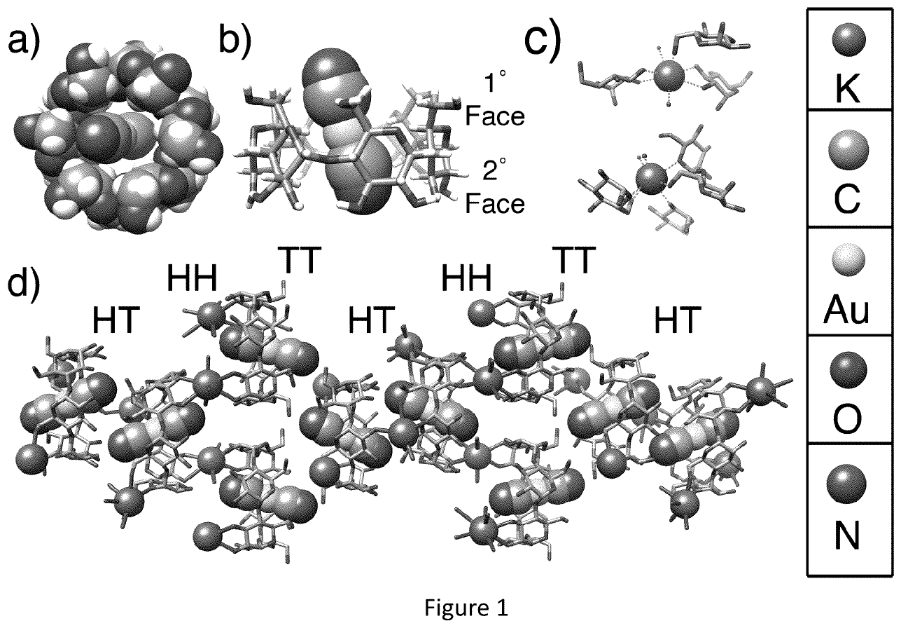

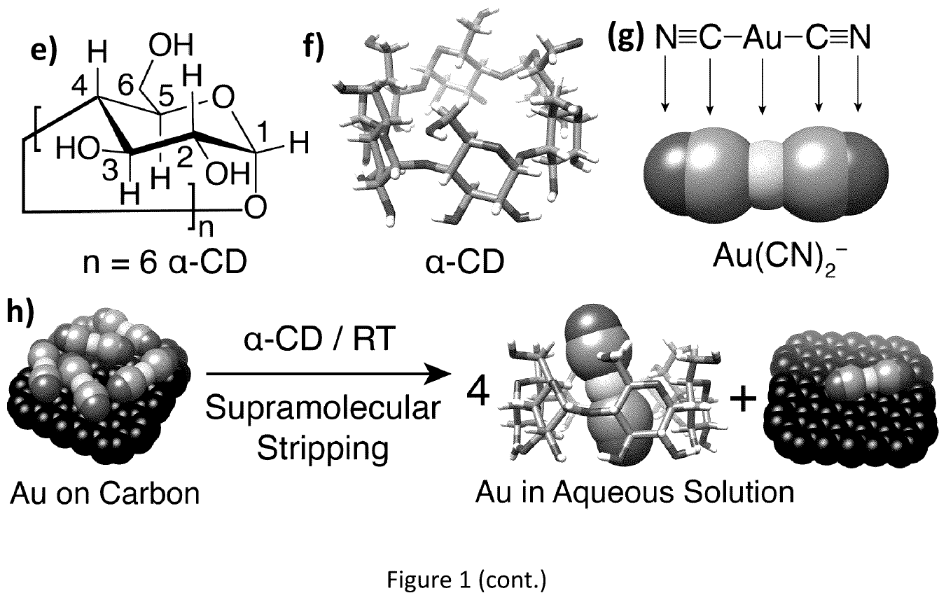

The above aspects of the technology are illustrated in detail in the following exemplary embodiments of the invention, which finds applications in gold stripping processes that can be conducted at room temperature and in the absence of harsh or toxic chemicals. In order to achieve room temperature stripping of gold, a molecular receptor is utilized for Au(CN)₂⁻ in aqueous solution to facilitate (FIG. 1 (e)-(h)) gold transfer from the surface of activated carbon into solution. Here we demonstrate the molecular recognition of Au(CN)₂⁻, a critical intermediate in today's gold-mining industry, using α-CD in water with a binding affinity in the order of 10⁴ M⁻¹. The binding mechanism has been investigated extensively using X-ray crystallography, ¹H NMR titrations, isothermal calorimetry titrations, and density functional theory (DFT) calculations. The Examples demonstrate that this anion recognition process can be applied to strip gold from the surface of activated carbon at room temperature. Also described is a selective stripping process for Au(CN)₂⁻ in the presence of Ag(CN)₂⁻, which has a lower binding affinity with α-CD. This process can be integrated into present gold-mining protocols and lead to significantly reduced costs, energy consumption, and environmental impact.

Single crystals of a 1:1 adduct were obtained by slow evaporation of an aqueous solution containing a mixture of α-CD and KAu(CN)₂. We note that α-CD (100 mM) requires heat for it to dissolve in H₂O. In the presence of KAu(CN)₂, α-CD dissolves instantly, suggesting that complexation is occuring. The solid-state superstructure of the 1:1 adduct between α-CD and Au(CN)₂⁻ is illustrated in FIG. 1. The Au(CN)₂⁻, which is encapsulated (FIGS. 1a and 1b) inside α-CD, is tilted by about 14° relative to its principal axis. Since the length (9.6 Å) of Au(CN)₂⁻ is slightly longer than the depth (7.9 Å) of the binding cavity, one of the cyanide ligands protrudes outside the primary face of α-CD. Five of the H-5 protons in α-CD are in short contact with the Au atom. The [Au . . . H-5] distances are in the range of 3.1-3.3 Å. One of the H-3 protons in α-CD is in short contact with a cyanide carbon, [N≡C . . . H-3] distance: 3.1 Å. Two of the H-3 protons in α-CD have short contacts with the cyanide nitrogens, [C≡N . . . H-3] distances: 2.9 and 3.4 Å. These short distances (Table 1 and Table 2) suggest that the supramolecular adduct Au(CN)₂⁻⊂α-CD is sustained by multiple [C—H . . . π]⁸⁴⁻⁸⁶ and [C—H . . . Anion]⁸⁷⁻⁹⁰ interactions between Au(CN)₂⁻ and the inwards-facing H-3, H-5 and H-6 protons. These noncovalent interactions are revealed^{91,92} by a reduced density gradient analysis. The K⁺ ions are located on both the primary and secondary faces of α-CD. Each K⁺ ion is linked to three α-CDs with a capped trigonal prismatic coordination geometry and a coordination number of seven, two of which are involved with water molecules as ligands. Two types of K⁺ ions are found (FIG. 1c) in the packing of the crystals. Type 1 K⁺ ions link one primary α-CD face and two of its secondary faces, while Type 2 K⁺ ions connect one secondary face and two primary faces of the α-CDs. The [K⁺ . . . O] ion-dipole distances are in the range 2.7-3.2 Å. The alignment (FIG. 1d) of α-CDs is in the repeating order of HT-HH-TT where H (head) represents the secondary face and T (tail) represents the primary face of the α-CDs. The HT and TT plane-to-plane distances ([O . . . O] from the OH groups on the opposing faces) are in the range 2.9-3.6 Å, and the HH plane-to-plane distances ([O . . . O] from the OH groups of the primary faces) are around 3.8 Å.

TABLE 1
The Intermolecular Distances^{a} Between KAu(CN)₂ and α-CD in
The Solid-State Superstructures With 1:1 and 1:2 Stoichiometries.

| Distances/Å | [Au•••H-5] | [Au•••H-6] | [NC•••H-3] | [CN•••H-3] | [CN•••H-5] | [K⁺•••O] |
|---|---|---|---|---|---|---|
| Au(CN)₂_{^{−}} ⊂ α-CD^{a} | 3.1-3.3/5 | >3.5 | 3.1/1 | 2.9-3.4/2 | >3.5 | 2.7-3.2/7 |
| Au(CN)₂_{^{−}} ⊂ (α-CD)₂^{b} | >3.5 | 3.4/1 | >3.5 | >3.5 | 2.8-3.2/7 | 2.7-3.2/7 |

^{a}These short distances suggest that the supramolecular complexes are sustained by multiple [CH•••π] and [CH•••Anion] interactions.
^{b}The number of protons from the glucose subunits involve in short contacts with Au(CN)₂_{^{−}} is presented after the slash symbol.

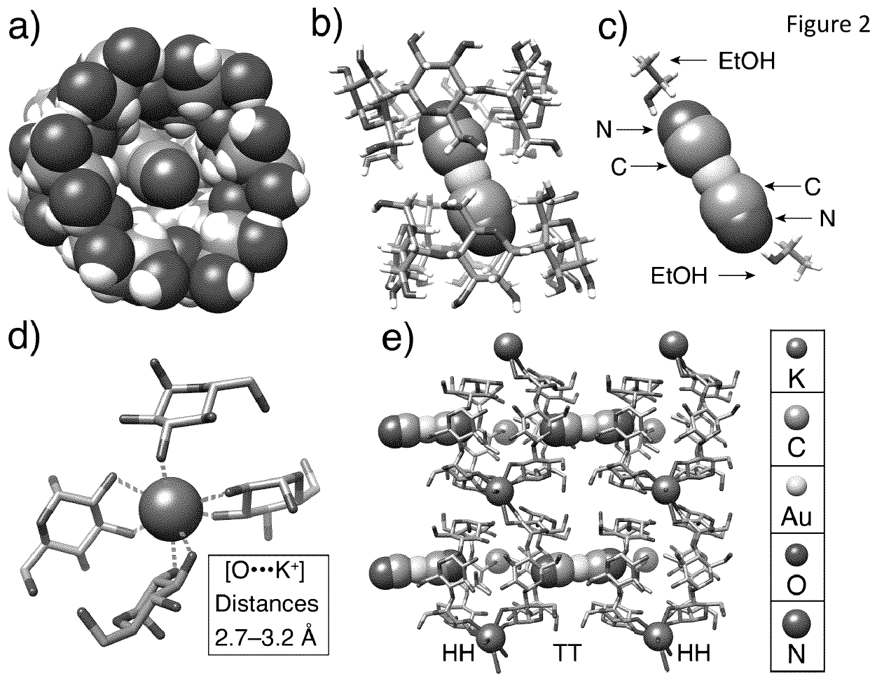

Single crystals of a 2:1 adduct were also obtained (FIG. 2) as a result of slow diffusion of EtOH into an aqueous solution containing a mixture of α-CD and KAu(CN)₂. The solid-state superstructure of the 2:1 adduct between α-CD and Au(CN)₂⁻ is illustrated in FIG. 2. The Au(CN)₂⁻ is located between two α-CD primary faces and is tilted by about 22° relative to its principal axis (FIG. 2a, b). There are seven H-5 protons from α-CD in close contact (Table 1 and 3) with the cyanide nitrogen atoms with [C≡N . . . H-5] distances in the range of 2.8-3.2 Å. One of the H-6 protons in α-CD has a [Au . . . H-6] contact with the distance of 3.4 Å. The multiple [C—H . . . π]⁸⁴⁻⁸⁶ and [C—H . . . Anion]⁸⁷⁻⁹⁰ interactions, which stabilize the 2:1 adduct between α-CD and Au(CN)₂⁻, are associated mainly with the inward-facing H-5 and H-6 protons. Next to each of the cyanide ligands is located an EtOH molecule, forming (FIG. 2c) a hydrogen bond with Au(CN)₂⁻. The binding energies of Au(CN)₂⁻ in the single crystal superstructure were determined by DFT calculations and are shown (Table 8) to be (i) to one α-CD (−42.4 kcal mol⁻¹), (ii) to both α-CDs (−79.4 kcal mol⁻¹), (iii) to one EtOH (−12.9 kcal mol⁻¹), (iv) to both EtOH (−22.5 kcal mol⁻¹), (v) to one EtOH and one α-CD (−62.8 kcal mol⁻¹), and (vi) to all, that is two α-CDs and two EtOH molecules (−119.8 kcal mol⁻¹). The EtOH molecules, which occupy part of the internal cavities of the α-CDs, enhance the overall stability of the 2:1 adduct and thus facilitate the shift in the binding stoichiometry from 1:1 to 2:1. The K⁺ ions are only found at the secondary faces of the α-CDs. Each K⁺ ion is linked (FIG. 2d) to four α-CDs with a capped trigonal prismatic coordination geometry and a coordination number of seven. The [K⁺ . . . O] ion-dipole distances are in the range 2.7-3.2 Å. The relative arrangement (FIG. 2e) of α-CDs repeats in the order HH and TT with plane-to-plane distances ([O . . . O] from the OH groups on the opposing primary faces and secondary faces) of 2.7-3.2 and 3.8-4.1 Å, respectively.

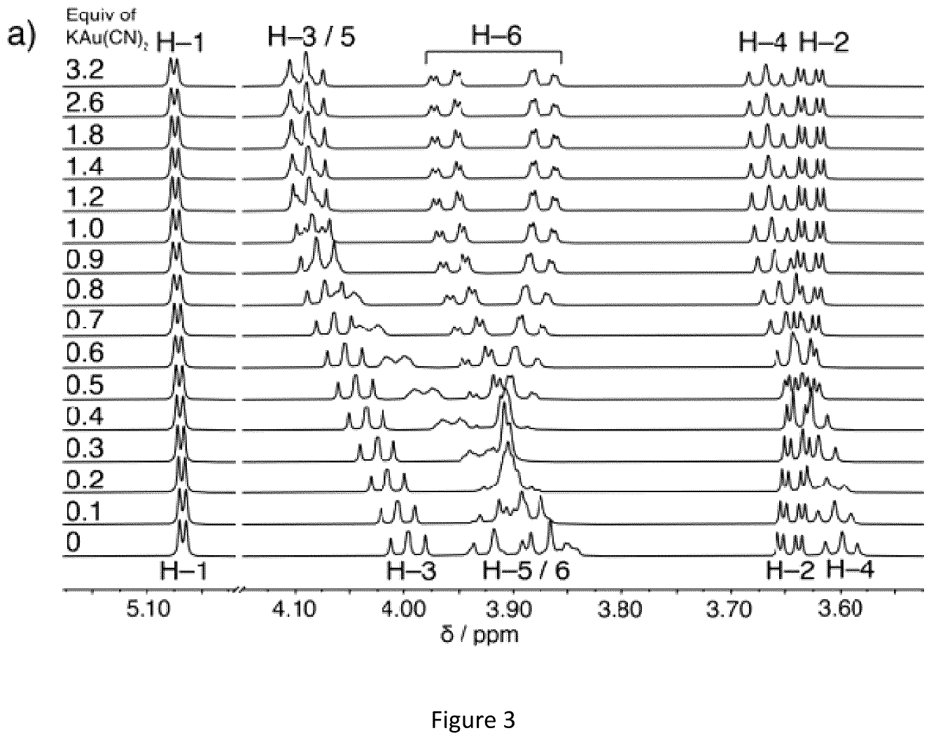

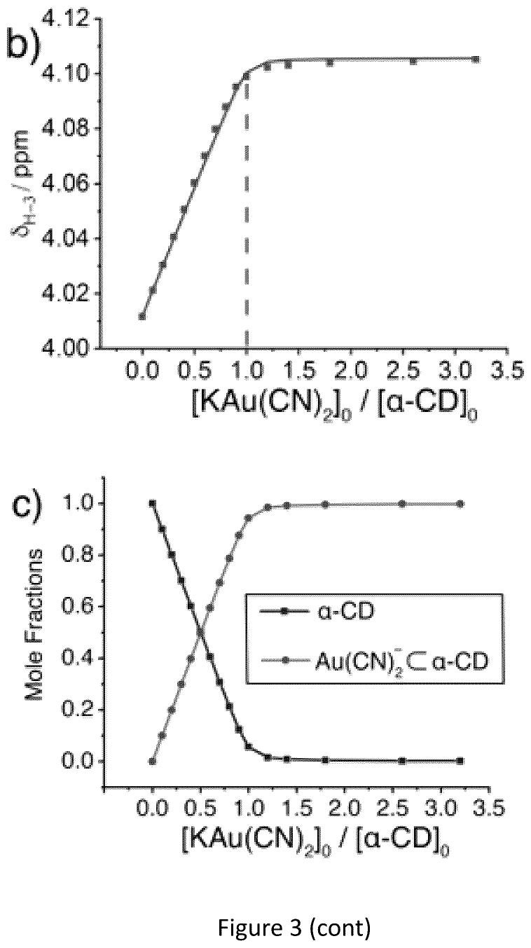

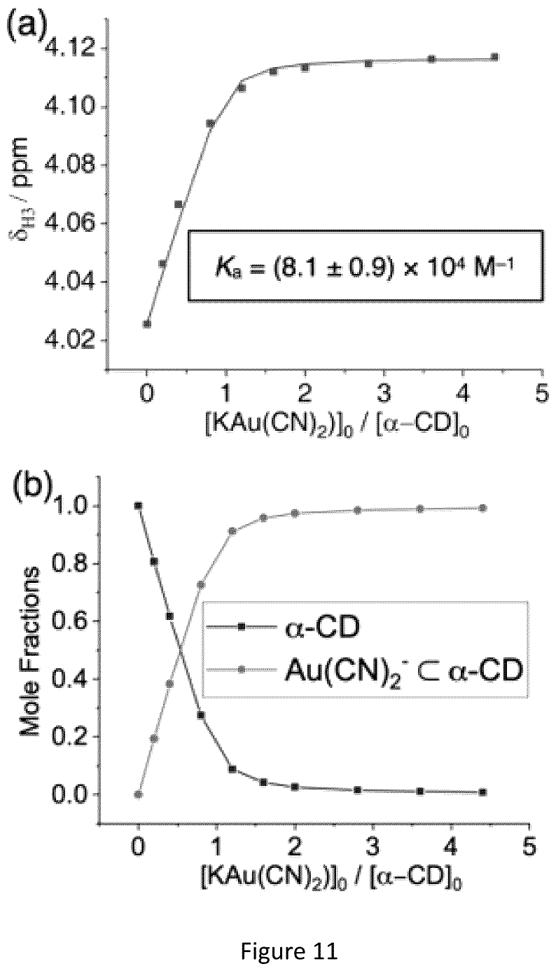

The association between α-CD and KAu(CN)₂ in D₂O was investigated by ¹H NMR titrations. Inner protons H-3 and H-5 (FIG. 1(e)) of α-CD are shifted (FIG. 3a) downfield upon binding with Au(CN)₂⁻. Following the chemical shift of H-3, the titration curve reveals (FIGS. 3b and 3c) a 1:1 binding stoichiometry commensurate with the solid-state superstructure obtained from the single crystal of the 1:1 adduct grown from aqueous solution. The binding constant (Kₐ) between Au(CN)₂⁻ and α-CD in D₂O was determined (FIG. 11) to be 8.1×10⁴ M⁻¹.

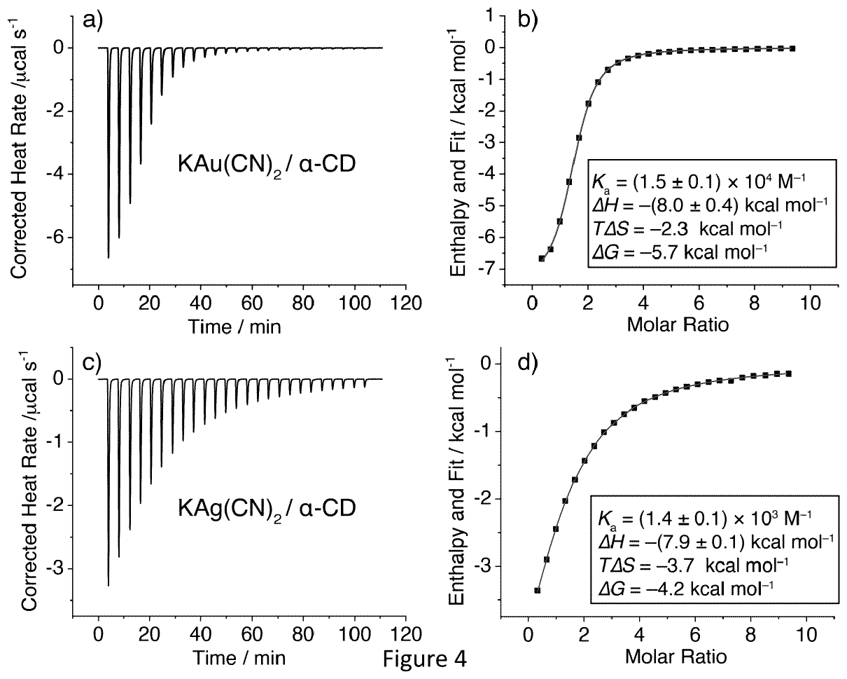

In order to shed more light on the driving force for the 1:1 adduct formation between Au(CN)₂⁻ and α-CD in water, isothermal titration calorimetry (ITC) was performed at 25° C. A stock aqueous solution of α-CD in a syringe was titrated into an aqueous solution of KAu(CN)₂ (0.5 mM) placed in a titration cell. The molecular recognition between α-CD and Au(CN)₂⁻ is accompanied (FIGS. 4a and 4b) by an exothermal process, where the binding enthalpy (ΔH) is found to be −8.0 kcal mol⁻¹. The titration curve follows a 1:1 binding model and produces a binding constant of 1.5×10⁴ M⁻¹. The Gibbs free energy of binding was determined to be −5.7 kcal mol⁻¹, which allows us to deduce a binding entropy that is associated with a TΔS value of −2.3 kcal mol⁻¹. These results suggest that the binding between Au(CN)₂⁻ and α-CD is driven by a favorable enthalpy change overcoming a small entropic penalty.

The binding affinity (Kₐ=1.4×10³ M⁻¹) between Ag(CN)₂⁻ (FIGS. 4c and 4d) and α-CD is an order of magnitude weaker compared with that of Au(CN)₂⁻. The binding enthalpy (ΔH=−7.9 kcal mol⁻¹) of Ag(CN)₂⁻ is similar to that of Au(CN)₂⁻, which is reasonable considering their similarities in size and shape. This similarity is corroborated (Table 5) by DFT calculations. The binding energy of the optimized Au(CN)₂⁻⊂α-CD is −35.6 kcal mol⁻¹, and that of the Ag(CN)₂⁻⊂α-CD is −36.2 kcal mol⁻¹.

The decrease in binding affinity of α-CD for Ag(CN)₂⁻ in H₂O is the result of a larger entropic penalty associated with a TΔS value of −3.7 kcal mol⁻¹, which can be attributable to the difference in hydration states of the Au(CN)₂⁻ and Ag(CN)₂⁻ ions in water. This result suggests that the binding of Au(CN)₂⁻ in water is most likely aided and abetted by hydrophobic effects⁹⁷⁻⁹⁹ that provide a favorable binding enthalpy by (i) releasing high-energy water from inside the α-CDs (ii) while reducing the entropic penalty resulting from the transfer of surface-bound water from the CDs and Au(CN)₂⁻ anions into the bulk solution.

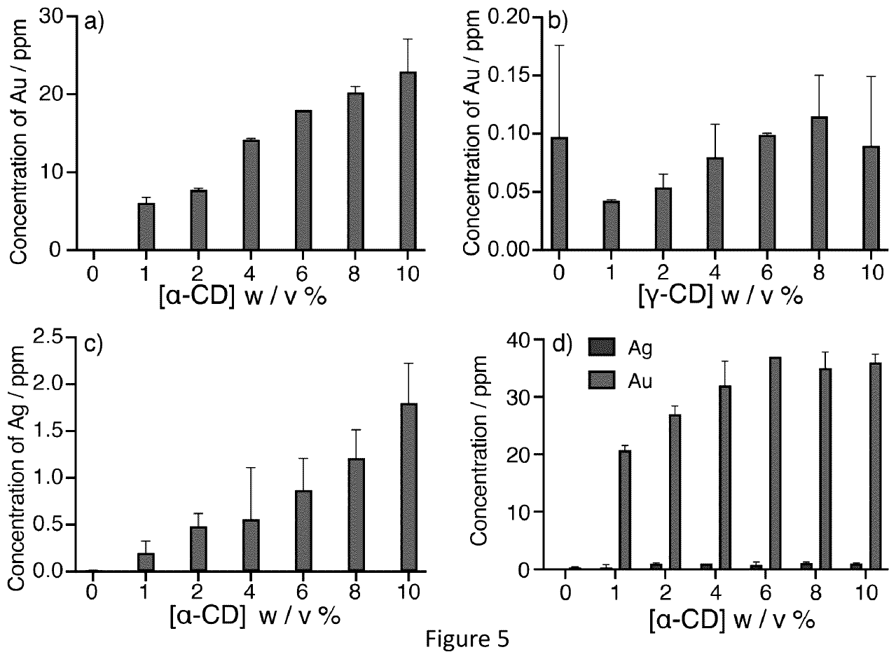

The high affinity of α-CD for Au(CN)₂⁻ anions in H₂O can be applied as a stripping agent to remove Au from the surface of activated carbon at room temperature. The Au-stripping experiments were performed at room temperature. An aqueous solution (5 mL) of α-CD at a range of concentrations (1-10% w/v) was mixed with Au-loaded carbon (50 mg, containing 0.6 mg Au) and the suspension was stirred for 30 min, after which time the carbon was isolated by filtration. The concentration of Au in the filtrate was determined by inductively coupled plasma mass spectrometry. The concentration of the stripped Au increases (FIG. 5a) when higher concentrations of α-CD are employed. When the concentration of Au reaches as high as 23 ppm, the corresponding Au-recovery efficiency is 19%. As a comparison, a blank aqueous solution elutes less than 0.1 ppm Au from the carbon, corresponding to a much lower recovery efficiency of 0.08%. In the presence of α-CD, the Au recovery efficiency is enhanced by a factor of 237. When using γ-CD, a lower affinity receptor for Au(CN)₂⁻, little enhancement of the Au stripping was observed (FIG. 5b). The high affinity of α-CD allows for successful stripping of Au from the surface of activated carbon.

Ag stripping using the same protocol was also tested. Compared with Au, the recovery (FIG. 5c) of Ag is much less efficient. The highest concentration of Ag stripped from the surface of activated carbon using 10% w/v α-CD is 1.8 ppm on account of the low binding affinity of α-CD with Ag(CN)₂⁻. A selective Au-stripping process from the surface of activated carbon loaded with Au and Ag was also evaluated. The concentration of stripped Au reached (FIG. 5d) as high as 37 ppm, while the concentration of Ag was below 1.2 ppm in all samples, suggesting a high stripping selectivity in favor of Au. In addition, it should be noted that a higher Au-stripping efficiency (31%) is achieved in the presence of Ag, which could compete with Au on the carbon surface and promote its desorption. The high stripping selectivity of Au over Ag from the surface of activated carbon allows for the use of molecular receptors for gold mining with high silver-containing ores in a carbon-in-pulp process.

The Examples demonstrate that molecular recognition of Au(CN)₂⁻ by α-cyclodextrin in aqueous solution with a binding affinity in the order of 10⁴ M⁻¹. The binding is driven by a favorable enthalpy against a small entropic penalty. The 1:1 and 2:1 adducts, respectively, between α-cyclodextrin and KAu(CN)₂ are sustained by multiple [C—H . . . π] and [C—H . . . Anion] interactions in addition to hydrophobic effects. The Examples also demonstrate that the molecular recognition between α-cyclodextrin and Au(CN)₂⁻ can be applied to strip gold from the surface of activated carbon at room temperature. We also show that α-cyclodextrin can strip selectively Au(CN)₂⁻ in the presence of Ag(CN)₂⁻, a process that is difficult to achieve using the current carbon-in-pulp process. These findings allow for integration into commercial gold-mining protocols and lead to significantly reduced costs, energy consumption, and environmental impact.

Unless otherwise specified or indicated by context, the terms “a”, “an”, and “the” mean “one or more.” For example, “a molecule” should be interpreted to mean “one or more molecules.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus ≤10% of the particular term and “substantially” and “significantly” will mean plus or minus >10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion additional components other than the components recited in the claims. The term “consisting essentially of” should be interpreted to be partially closed and allowing the inclusion only of additional components that do not fundamentally alter the nature of the claimed subject matter.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### REFERENCES

(1) Gold Ore Processing: Project Development and Operations; Adams, M. D., Ed.; Elsevier: Singapore, 2016.
(2) Hutchings, G. J.; Brust, M.; Schmidbaur, H. Gold-An Introductory Perspective. Chem. Soc. Rev. 2008, 37, 1759-1765.
(3) Gorin, D. J.; Toste, F. D. Relativistic Effects in Homogeneous Gold Catalysis. Nature 2007, 446, 395-403.
(4) Puddephatt, R. J. Macrocycles, Catenanes, Oligomers and Polymers in Gold Chemistry. Chem. Soc. Rev. 2008, 37, 2012-2027.
(5) Corma, A.; Garci, H. Supported Gold Nanoparticles as Catalysts for Organic Reactions. Chem. Soc. Rev. 2008, 37, 2096-2126.
(6) Goldup, S. M.; Leigh, D. A.; Lusby, P. J.; McBurney, R. T.; Slawin, A. M. Z. Gold (I)-Template Catenane and Rotaxane Synthesis. Angew. Chem. Int. Ed. 2008, 47, 6999-7003.
(7) Galli, M.; Lewis, J. E. M.; Goldup, S. M. A Stimuli-Responsive Rotaxane-Gold Catalyst: Regulation of Activity and Diastereoselectivity. Angew. Chem. Int. Ed. 2015, 54, 13545-13549.
(8) Pflästerer, D.; Hashmi, A. S. K. Gold Catalysis in Total Synthesis-Recent Achievements. Chem. Soc. Rev. 2016, 45, 1331-1367.
(9) Lewis, J. E. M.; Beer, P. D.; Loeb, S. J.; Goldup, S. M. Metal Ions in the Synthesis of Interlocked Molecules and Materials. Chem. Soc. Rev. 2017, 46, 2577-2591.
(10) Taschinski, S.; Döpp, R.; Ackermann, M.; Rominger, F.; de Vries, F.; Menger, M. F. S. J.; Rudolph, M.; Hashmi, A. S. K.; Klein, J. E. M. N. Light-Induced Mechanistic Divergence in Gold(I) Catalysis: Revisiting the Reactivity of Diazonium Salts. Angew. Chem. Int. Ed. 2019, 58, 16988-16993.
(11) Grzelczak, M.; Pérez-Juste, J.; Mulvaney, P.; Liz-Marzán, L. M. Shape Control in Gold Nanoparticle Synthesis. Chem. Soc. Rev. 2008, 37, 1783-1791.
(12) Giljohann, D. A.; Seferos, D. S.; Daniel, W. L.; Massich, M. D.; Patel, P. C.; Mirkin, C. A. Gold Nanoparticles for Biology and Medicine. Angew. Chem. Int. Ed. 2010, 49, 3280-3294.
(13) Saha, K.; Agasti, S. S.; Kim, C.; Li, X.; Rotello, V. M. Gold Nanoparticles in Chemical and Biological Sensing. Chem. Rev. 2012, 112, 2739-2779.
(14) Personick, M. L.; Mirkin, C. A. Making Sense of the Mayhem Behind Shape Control in the Synthesis of Gold Nanoparticles. J. Am. Chem. Soc. 2013, 135, 18238-18247.
(15) Bishop, P. T.; Ashfield, L. J.; Berzins, A.; Boardman, A.; Buche, V.; Cookson, J.; Gordon, R. J.; Salcianu, C.; Sutton, P. A. Printed Gold for Electronic Applications. Gold Bull. 2010, 43, 181-188.
(16) Goodman, P. Current and Future Uses of Gold in Electronics. Gold Bull. 2002, 35, 21-26.
(17) Online, V. Biological Applications of Gold Nanoparticles. Chem. Soc. Rev. 2008, 37, 1909-1930.
(18) Boisselier, E.; Astruc, D. Gold Nanoparticles in Nanomedicine: Preparations, Imaging, Diagnostics, Therapies and Toxicity. Chem. Soc. Rev. 2009, 38, 1759-1782.
(19) Yang, Z.; Jiang, G.; Xu, Z.; Zhao, S.; Liu, W. Advances in Alkynyl Gold Complexes for Use as Potential Anticancer Agents. Coord. Chem. Rev. 2020, 423, 213492.
(20) Hilson, G.; Monhemius, A. J. Alternatives to Cyanide in the Gold Mining Industry: What Prospects for the Future? J. Clean. Prod. 2006, 14, 1158-1167.
(21) Hagelüken, C.; Corti, C. W. Recycling of Gold from Electronics: Cost-Effective Use through “Design for Recycling.” Gold Bull. 2010, 43, 209-220.
(22) Syed, S. Recovery of Gold from Secondary Sources—A Review. Hydrometallurgy 2012, 115-116, 30-51.
(23) Nelson, J. J. M.; Schelter, E. J. Sustainable Inorganic Chemistry: Metal Separations for Recycling. Inorg. Chem. 2019, 58, 979-990.
(24) Rao, M. D.; Singh, K. K.; Morrison, C. A.; Love, J. B. Challenges and Opportunities in the Recovery of Gold from Electronic Waste. RSC Adv. 2020, 10, 4300-4309.
(25) Adams, M. D. The Mechanism of Adsorption of Aurocyanide onto Activated Carbon, 1. Relation between the Effects of Oxygen and Ionic Strength. Hydrometallurgy 1990, 25, 171-184.
(26) Adams, M. D.; McDougall, G. J.; Hancock, R. D. Models for the Adsorption of Aurocyanide onto Activated Carbon. Part II: Extraction of Aurocyanide Ion Pairs by Polymeric Adsorbents. Hydrometallurgy 1987, 18, 139-154.
(27) Zadra, J. B. A Process for the Recovery of Gold from Activated Carbon by Leaching and Electrolysis; Report of Investigations/United States Department of the Interior, Bureau of Mines; U.S. Department of the Interior, Bureau of Mines, 1950.
(28) Ubaldini, S.; Massidda, R.; Vegliò, F.; Beolchini, F. Gold Stripping by Hydro-Alcoholic Solutions from Activated Carbon: Experimental Results and Data Analysis by a Semi-Empirical Model. Hydrometallurgy 2006, 81, 40-44.
(29) Soleimani, M.; Kaghazchi, T. Gold Recovery from Loaded Activated Carbon Using Different Solvents. J. Chinese Inst. Chem. Eng. 2008, 39, 9-11.
(30) Bunney, K.; Jeffrey, M. I.; Pleysier, R.; Breuer, P. L. Selective Elution of Gold, Silver and Mercury Cyanide from Activated Carbon. Miner. Metall. Process. 2010, 27, 205-211.
(31) Liu, Z.; Frasconi, M.; Lei, J.; Brown, Z. J.; Zhu, Z.; Cao, D.; Iehl, J.; Liu, G.; Fahrenbach, A. C.; Botros, Y. Y.; Farha, O. K.; Hupp, J. T.; Mirkin, C. A.; Stoddart, J. F. Selective Isolation of Gold Facilitated by Second-Sphere Coordination with a-Cyclodextrin. Nat. Commun. 2013, 4, 1855.
(32) Liu, Z.; Samanta, A.; Lei, J.; Sun, J.; Wang, Y.; Stoddart, J. F. Cation-Dependent Gold Recovery with α-Cyclodextrin Facilitated by Second-Sphere Coordination. J. Am. Chem. Soc. 2016, 138, 11643-11653.
(33) Fissaha, H. T.; Torrejos, R. E. C.; Kim, H.; Chung, W. J.; Nisola, G. M. Thia-Crown Ether Functionalized Mesoporous Silica (SBA-15) Adsorbent for Selective Recovery of Gold (Au³⁺) Ions from Electronic Waste Leachate. Microporous Mesoporous Mater. 2020, 305, 110301.
(34) Lin, R.-L.; Dong, Y.-P.; Tang, M.; Liu, Z.; Tao, Z.; Liu, J.-X. Selective Recovery and Detection of Gold with Cucurbit[n]urils (n=5-7). Inorg. Chem. 2020, 59, 3850-3855.
(35) Chen, L.-X.; Liu, M.; Zhang, Y.-Q.; Zhu, Q.-J.; Liu, J.-X.; Zhu, B.-X.; Tao, Z. Outer Surface Interactions to Drive Cucurbit[8]uril-Based Supramolecular Frameworks: Possible Application in Gold Recovery. Chem. Commun. 2019, 55, 14271-14274.
(36) Wu, H.; Jones, L. O.; Wang, Y.; Shen, D.; Liu, Z.; Zhang, L.; Cai, K.; Jiao, Y.; Stern, C. L.; Schatz, G. C.; Stoddart, J. F. High-Efficiency Gold Recovery Using Cucurbit[6]uril. ACS Appl. Mater. Interfaces 2020, 12, 38768-38777.
(37) Serpell, C. J.; Cookson, J.; Ozkaya, D.; Beer, P. D. Core@shell Bimetallic Nanoparticle Synthesis via Anion Coordination. Nat. Chem. 2011, 3, 478-483.
(38) Wang, L.-L.; Tu, Y.-K.; Yao, H.; Jiang, W. 2,3-Dibutoxynaphthalene-Based Tetralactam Macrocycles for Recognizing Precious Metal Chloride Complexes. Beilstein J. Org. Chem. 2019, 15, 1460-1467.
(39) Doidge, E. D.; Carson, I.; Tasker, P. A.; Ellis, R. J.; Morrison, C. A.; Love, J. B. A Simple Primary Amide for the Selective Recovery of Gold from Secondary Resources. Angew. Chem. Int. Ed. 2016, 55, 12436-12439.
(40) Liu, W.; Oliver, A. G.; Smith, B. D. Macrocyclic Receptor for Precious Gold, Platinum, or Palladium Coordination Complexes. J. Am. Chem. Soc. 2018, 140, 6810-6813.
(41) Doidge, E. D.; Kinsman, L. M. M.; Ji, Y.; Carson, I.; Duffy, A. J.; Kordas, I. A.; Shao, E.; Tasker, P. A.; Ngwenya, B. T.; Morrison, C. A.; Love, J. B. Evaluation of Simple Amides in the Selective Recovery of Gold from Secondary Sources by Solvent Extraction. ACS Sustain. Chem. Eng. 2019, 7, 15019-15029.
(42) Shaffer, C. C.; Liu, W.; Oliver, A. G.; Smith, B. D. Supramolecular Paradigm for Capture and Co-Precipitation of Gold(III) Coordination Complexes. Chem. Eur. J. 2020, doi: 10.1002/chem.202003680.
(43) Dai, Y.; Zheng, K.; Tan, Y.; Xiang, W.; Xianyu, B.; Xu, H. Fischesserite-Inspired Recyclable Se-Polyurethanes for Selective Gold Extraction. Adv. Sustain. Syst. 2020, 4, 1-6.
(44) Dong, C.-C.; Xiang, J.-F.; Xu, L.-J.; Gong, H.-Y. MCl4ⁿ⁻ (AuCl₄⁻, PtCl₄²⁻, or PdCl₄²⁻) Anion Extraction from NaₙMCl₄ in Water Using a Tetraimidazolium Macrocyclic Receptor. Tetrahedron Lett. 2018, 59, 264-267.
(45) Sun, D. T.; Gasilova, N.; Yang, S.; Oveisi, E.; Queen, W. L. Rapid, Selective Extraction of Trace Amounts of Gold from Complex Water Mixtures with a Metal-Organic Framework (MOF)/Polymer Composite. J. Am. Chem. Soc. 2018, 140, 16697-16703.
(46) Zhou, S.; Hu, C.; Xu, W.; Mo, X.; Zhang, P.; Liu, Y.; Tang, K. Fast Recovery of Au(III) and Ag(I) via Amine-Modified Zeolitic Imidazolate Framework-8. Appl. Organomet. Chem. 2020, 34, e5541.
(47) Wang, C.; Lin, G.; Zhao, J.; Wang, S.; Zhang, L. Enhancing Au(III) Adsorption Capacity and Selectivity via Engineering MOF with Mercapto-1,3,4-thiadiazole. Chem. Eng. J. 2020, 388, 124221.
(48) Nguyen, T. S.; Hong, Y.; Dogan, N. A.; Yavuz, C. T. Gold Recovery from e-Waste by Porous Porphyrin-Phenazine Network Polymers. Chem. Mater. 2020, 32, 5343-5349.
(49) Ma, T.; Zhao, R.; Li, Z.; Jing, X.; Faheem, M.; Song, J.; Tian, Y.; Lv, X.; Shu, Q.; Zhu, G. Efficient Gold Recovery from e-Waste via a Chelate-Containing Porous Aromatic Framework. ACS Appl. Mater. Interfaces 2020, 12, 30474-30482.
(50) Hong, Y.; Thirion, D.; Subramanian, S.; Yoo, M.; Choi, H.; Kim, H. Y.; Stoddart, J. F.; Yavuz, C. T. Precious Metal Recovery from Electronic Waste by a Porous Porphyrin Polymer. Proc. Natl. Acad. Sci. USA 2020, 117, 16174-16180.
(51) Snowden, T. S.; Anslyn, E. V. Anion Recognition: Synthetic Receptors for Anions and Their Application in Sensors. Curr. Opin. Chem. Biol. 1999, 3, 740-746.
(52) Kubik, S. Anion Recognition in Water. Chem. Soc. Rev. 2010, 39, 3648-3663.
(53) Xu, Z.; Kim, S. K.; Yoon, J. Revisit to Imidazolium Receptors for the Recognition of Anions: Highlighted Research during 2006-2009. Chem. Soc. Rev. 2010, 39, 1457-1466.
(54) Brotherhood, P. R.; Davis, A. P. Steroid-Based Anion Receptors and Transporters. Chem. Soc. Rev. 2010, 39, 3633-3647.
(55) Busschaert, N.; Caltagirone, C.; Van Rossom, W.; Gale, P. A. Applications of Supramolecular Anion Recognition. Chem. Rev. 2015, 115, 8038-8155.
(56) Flood, A. H. Creating Molecular Macrocycles for Anion Recognition. Beilstein J. Org. Chem. 2016, 12, 611-627.
(57) Liu, Y.; Sengupta, A.; Raghavachari, K.; Flood, A. H. Anion Binding in Solution: Beyond the Electrostatic Regime. Chem 2017, 3, 411-427.
(58) Kubik, S. Anion Recognition in Aqueous Media by Cyclopeptides and Other Synthetic Receptors. Acc. Chem. Res. 2017, 50, 2870-2878.
(59) He, Q.; Tu, P.; Sessler, J. L. Supramolecular Chemistry of Anionic Dimers, Trimers, Tetramers, and Clusters. Chem 2018, 4, 46-93.
(60) He, Q.; Vargas-Zúñiga, G. I.; Kim, S. H.; Kim, S. K.; Sessler, J. L. Macrocycles as Ion Pair Receptors. Chem. Rev. 2019, 119, 9753-9835.
(61) Chen, L.; Berry, S. N.; Wu, X.; Howe, E. N. W.; Gale, P. A. Advances in Anion Receptor Chemistry. Chem 2020, 6, 61-141.
(62) Hein, R.; Beer, P. D.; Davis, J. J. Electrochemical Anion Sensing: Supramolecular Approaches. Chem. Rev. 2020, 120, 1888-1935.
(63) Wang, D.-X.; Wang, M.-X. Exploring Anion-x Interactions and Their Applications in Supramolecular Chemistry. Acc. Chem. Res. 2020, 53, 1364-1380.
(64) Pancholi, J.; Beer, P. D. Halogen Bonding Motifs for Anion Recognition. Coord. Chem. Rev. 2020, 416, 213281.
(65) Wu, X.; Gilchrist, A. M.; Gale, P. A. Prospects and Challenges in Anion Recognition and Transport. Chem 2020, 6, 1296-1309.
(66) Canumalla, A. J.; Schraa, S.; Isab, A. A.; Shaw, C. F.; Gleichmann, E.; Dunemann, L.; Turfeld, M. Equilibrium Binding Constants and Facile Dissociation of Novel Serum Albumin-Dicyanoaurate(I) Complexes. J. Biol. Inorg. Chem. 1998, 3, 9-17.
(67) Pham, D. M.; Rios, D.; Olmstead, M. M.; Balch, A. L. Assisted Self-Association of Dicyanoaurate, [Au(CN)₂]⁻, and Dicyanoargentate, [Ag(CN)₂]⁻, Through Hydrogen Bonding to Metal Ammonia Complexes. Inorg. Chim. Acta 2005, 358, 4261-4269.
(68) Moriuchi, T.; Yoshii, K.; Katano, C.; Hirao, T. Luminescent Properties of Dicyanoaurate(I) Aggregates Based on Electrostatic Assembly along Poly(Allylamine Hydrochloride). Tetrahedron Lett. 2010, 51, 4030-4032.
(69) Meng, W.; Clegg, J. K.; Nitschke, J. R. Transformative Binding and Release of Gold Guests from a Self-Assembled Cu₈L₄ Tube. Angew. Chem. Int. Ed. 2012, 51, 1881-1884.
(70) Meng, W.; League, A. B.; Ronson, T. K.; Clegg, J. K.; Isley, W. C.; Semrouni, D.; Gagliardi, L.; Cramer, C. J.; Nitschke, J. R. Empirical and Theoretical Insights into the Structural Features and Host-Guest Chemistry of M₈L₄ Tube Architectures. J. Am. Chem. Soc. 2014, 136, 3972-3980.
(71) Christopherson, J. C.; Potts, K. P.; Bushuyev, O. S.; Topić, F.; Huskić, I.; Rissanen, K.; Barrett, C. J.; Friščić, T. Assembly and Dichroism of a Four-Component Halogen-Bonded Metal-Organic Cocrystal Salt Solvate Involving Dicyanoaurate(I) Acceptors. Faraday Discuss. 2017, 203, 441-457.
(72) Andersen, N. N.; Eriksen, K.; Lisbjerg, M.; Ottesen, M. E.; Milhøj, B. O.; Sauer, S. P. A.; Pittelkow, M. Entropy/Enthalpy Compensation in Anion Binding: Biotin[6]uril and Biotin-1-Sulfoxide[6]Uril Reveal Strong Solvent Dependency. J. Org. Chem. 2019, 84, 2577-2584.
(73) Villiers, A. Sur La Fermentation de La Fécule Par L'action Du Ferment Butyrique. C.R. Acad. Sci. 1891, 112, 536.
(74) Stoddart, J. F. A Century of Cyclodextrins. Carbohydr. Res. 1989, 192, 12-15.
(75) Szejtli, J. Past, Present and Future of Cyclodextrin Research. Pure Appl. Chem. 2004, 76, 1825-1845.
(76) Crini, G. Review: A History of Cyclodextrins. Chem. Rev. 2014, 114, 10940-10975.
(77) Smaldone, R. A.; Forgan, R. S.; Furukawa, H.; Gassensmith, J. J.; Slawin, A. M. Z.; Yaghi, O. M.; Stoddart, J. F. Metal-Organic Frameworks from Edible Natural Products. Angew. Chem. Int. Ed. 2010, 49, 8630-8634.
(78) Liu, Z.; Stoddart, J. F. Extended Metal-Carbohydrate Frameworks. Pure Appl. Chem. 2014, 86, 1323-1334.
(79) Liu, Z.; Schneebeli, S. T.; Stoddart, J. F. Second-Sphere Coordination Revisited. Chimia (Aarau). 2014, 68, 315-320.
(80) Harada, A.; Li, J.; Kamachi, M. The Molecular Necklace: A Rotaxane Containing Many Threaded a-Cyclodextrins. Nature 1992, 356, 325-327.
(81) Noltemeyer, M.; Saenger, W. X-Ray Studies of Linear Polyiodide Chains in α-Cyclodextrin Channels and a Model for the Starch-Iodine Complex. Nature 1976, 259, 629-632.
(82) Noltemeyer, M.; Saenger, W. Topography of Cyclodextrin Inclusion Complexes. 12. Structural Chemistry of Linear.Alpha.-Cyclodextrin-Polyiodide Complexes. X-Ray Crystal Structures of (.Alpha.-Cyclodextrin)2.LiI₃.I_{2.8}H₂O and (.Alpha.-Cyclodextrin)₂.Cd_{0.5}).I_{5.27}H₂O. Models for the Blue. J. Am. Chem. Soc. 1980, 102, 2710-2722.
(84) Spiwok, V. CH/π Interactions in Carbohydrate Recognition. Molecules 2017, 22, 1-11.
(85) Nishio, M.; Umezawa, Y.; Fantini, J.; Weiss, M. S.; Chakrabarti, P. CH-π Hydrogen Bonds in Biological Macromolecules. Phys. Chem. Chem. Phys. 2014, 16, 12648-12683.
(86) Nishio, M. The CH/π Hydrogen Bond in Chemistry. Conformation, Supramolecules, Optical Resolution and Interactions Involving Carbohydrates. Phys. Chem. Chem. Phys. 2011, 13, 13873-13900.
(87) Ilioudis, C. A.; Tocher, D. A.; Steed, J. W. A Highly Efficient, Preorganized Macrobicyclic Receptor for Halides Based on CH . . . and NH . . . Anion Interactions. J. Am. Chem. Soc. 2004, 126, 12395-12402.
(88) Vega, I. E. D.; Gale, P. A.; Light, M. E.; Loeb, S. J. NH vs. CH Hydrogen Bond Formation in Metal-Organic Anion Receptors Containing Pyrrolylpyridine Ligands. Chem. Commun. 2005, 39, 4913-4915.
(89) Pedzisa, L.; Hay, B. P. Aliphatic C—H . . . anion Hydrogen Bonds: Weak Contacts or Strong Interactions? J. Org. Chem. 2009, 74, 2554-2560.
(90) Lisbjerg, M.; Valkenier, H.; Jessen, B. M.; Al-Kerdi, H.; Davis, A. P.; Pittelkow, M. Biotin[6]uril Esters: Chloride-Selective Transmembrane Anion Carriers Employing C—H . . . Anion Interactions. J. Am. Chem. Soc. 2015, 137, 4948-4951.
(91) Lefebvre, C.; Rubez, G.; Khartabil, H.; Boisson, J. C.; Contreras-García, J.; Hénon, E. Accurately Extracting the Signature of Intermolecular Interactions Present in the NCI Plot of the Reduced Density Gradient Versus Electron Density. Phys. Chem. Chem. Phys. 2017, 19, 17928-17936.
(92) Lu, T.; Chen, F. Multiwfn: A Multifunctional Wavefunction Analyzer. J. Comput. Chem. 2012, 33, 580-592.
(97) Biedermann, F.; Nau, W. M.; Schneider, H. J. The Hydrophobic Effect Revisited-Studies with Supramolecular Complexes Imply High-Energy Water as a Noncovalent Driving Force. Angew. Chem. Int. Ed. 2014, 53, 11158-11171.
(98) Snyder, P. W.; Lockett, M. R.; Moustakas, D. T.; Whitesides, G. M. Is It the Shape of the Cavity, or the Shape of the Water in the Cavity? Eur. Phys. J. Specia Top. 2014, 223, 853-891.
(99) Hillyer, M. B.; Gibb, B. C. Molecular Shape and the Hydrophobic Effect. Annu. Rev. Phys. Chem. 2016, 67, 307-329.
(100) Colquhoun, H. M.; Stoddart, J. F.; Williams, D. J. Second-Sphere Coordination—A Novel Role for Molecular Receptors. Angew. Chem. Int. Ed. 1986, 25, 487-507.
(101) Alston, D. R.; Ashton, P. R.; Lilley, T. H.; Fraser Stoddart, J.; Zarzycki, R.; Slawin, A. M. Z.; Williams, D. J. Second-Sphere Coordination of Carboplatin and Rhodium Complexes by Cyclodextrins (Cyclomalto-Oigo-Saccharides). Carbohydr. Res. 1989, 192, 259-281.
(102) Raymo, F. M.; Stoddart, J. F. Second-Sphere Coordination. Chem. Ber. 1996, 129, 981-990.
(103) Alston, D. R.; Lilley, T. H.; Stoddart, J. F. The Binding of Cyclobutane-1,1-Dicarboxylatodiammineplatinum(II) by Alpha-Cyclodextrin in Aqueous Solution. J. Chem. Soc., Chem. Commun. 1985, 22, 1600-1602.
(104) Alston, D. R.; Slawin, A. M. Z.; Stoddart, J. F.; Williams, D. J. The X-Ray Crystal Structure of a 1:1 Adduct between a-Cyclodextrin and Cyclobutane-1,1-Dicarboxylatodiammineplatinum(II). J. Chem.Soc., Chem. Commun. 1985, 22, 1602-1604.
(105) Alston, D. R.; Slawin, A. M. Z.; Stoddart, J. F.; Williams, D. J. Cyclodextrins as Second Sphere Ligands for Transition Metal Complexes-The X-Ray Crystal Structure of [Rh(Cod)(NH₃)₂.α-cyclodextrin][PF₆].6H₂O. Angew. Chem. Int. Ed. 1985, 24, 786-787.
(106) Alston, D. R.; Slawin, A. M. Z.; Stoddart, J. F.; Williams, D. J.; Zarzycki, R. Second Sphere Coordination Adducts of Phosphane-Transition Metal Complexes with β-Cyclodextrin and Its Methylated Derivative. Angew. Chem. Int. Ed. 1988, 27, 1184-1185.

### EXAMPLES

The invention solves the commercial problems faced by today's gold-mining protocol, which requires the use of harsh conditions, including high temperature, high-pressure operation, and the use of toxic, corrosive and environmentally objectable chemicals, namely, NaCN and NaOH.

Molecular recognition of the Au(CN)₂⁻ anion, a crucial intermediate in today's gold mining industry, by α-cyclodextrin is demonstrated. Three X-ray single-crystal superstructures, KAu(CN)₂⊂α-cyclodextrin, KAu(CN)₂⊂(α-cyclodextrin)₂ and KAg(CN)₂⊂(α-cyclodextrin)₂, demonstrate that the binding cavity of α-cyclodextrin is a good fit for metal-coordination complexes, such as Au(CN)₂⁻ and Ag(CN)₂⁻ with linear geometries, while the K⁺ ions fulfil the role of linking α-cyclodextrin tori together as a result of [K⁺ . . . O] ion-dipole interactions. A 1:1 binding stoichiometry between Au(CN)₂⁻ and α-cyclodextrin in aqueous solution, revealed by ¹H NMR titrations, has produced binding constants in the order of 10⁴ M⁻¹. Isothermal calorimetry titrations indicate that this molecular recognition is driven by a favorable enthalpy change overcoming a small entropic penalty. The adduct formation of KAu(CN)₂⊂α-cyclodextrin in aqueous solution is sustained by multiple [C—H . . . π] and [C—H . . . Anion] interactions in addition to hydrophobic effects. The molecular recognition has also been investigated by DFT calculations, which suggest that the 2:1 binding stoichiometry between α-cyclodextrin and Au(CN)₂⁻ is favored in the presence of ethanol. This molecular recognition process between α-cyclodextrin and KAu(CN)₂ can be applied to the stripping of gold from the surface of activated carbon at room temperature. Moreover, this stripping process is selective for Au(CN)₂⁻ in the presence of Ag(CN)₂⁻, which has a lower binding affinity toward α-cyclodextrin. This molecular recognition process allows for integration into commercial gold-mining protocols and lead to significantly reduced costs, energy consumption, and environmental impact.

### Crystallographic Analyses

### (1) Crystal Superstructure of KAu(CN)₂⊂α-CD

(a) Method: Colorless block-like single crystals were obtained by slow evaporation of an aqueous solution (300 μL) containing KAu(CN)₂ (8.9 mg) and α-CD (30 mg) at room temperature for 30 days. A suitable crystal was selected, and the crystal was mounted on a MITIGEN holder with Paratone oil on a XtaLAB Synergy, Single source at home/near, HyPix diffractometer. The crystal was kept at 100.02(10) K during data collection. Using Olex2^{S1}, the superstructure was solved with the ShelXT^{S2} structure solution program using Intrinsic Phasing and refined with the XL^{S3} refinement package using Least Squares minimization.
(b) Crystal Parameters: Empirical formula=C₃₈H₇₄AuKN₂O₃₇, formula weight=1387.05, orthorhombic, space group P2₁2₁2₁ (no. 19), a=13.99063(13), b=23.4405(2), c=51.2967(4) Å, V=16822.6(3) Å³, Z=12, T=100.02(10) K, μ(CuKα)=6.517 mm⁻¹, D_{calc}=1.643 g/mm³, 97178 reflections measured (6.548≤2Θ≤160.584), 34431 unique (Rᵢₙₜ=0.0607, R_{sigma}=0.0620) which were used in all calculations. The final R₁ was 0.0588 (I>2σ(I)) and wR₂ was 0.1474 (all data).
(c) Refinement Details: The enhanced rigid-bond restraint (SHELX keyword RIGU) was applied^{S4} globally.

(d) Solvent Treatment Details: The solvent masking procedure implemented in Olex2 was used to remove the electronic contribution of solvent molecules from the refinement. As the exact solvent content is unknown, only the atoms used in the refinement model are reported in the formula here. Total solvent-accessible volume/cell=889.1 Å³ [5.3%] Total electron count/cell=175.9.

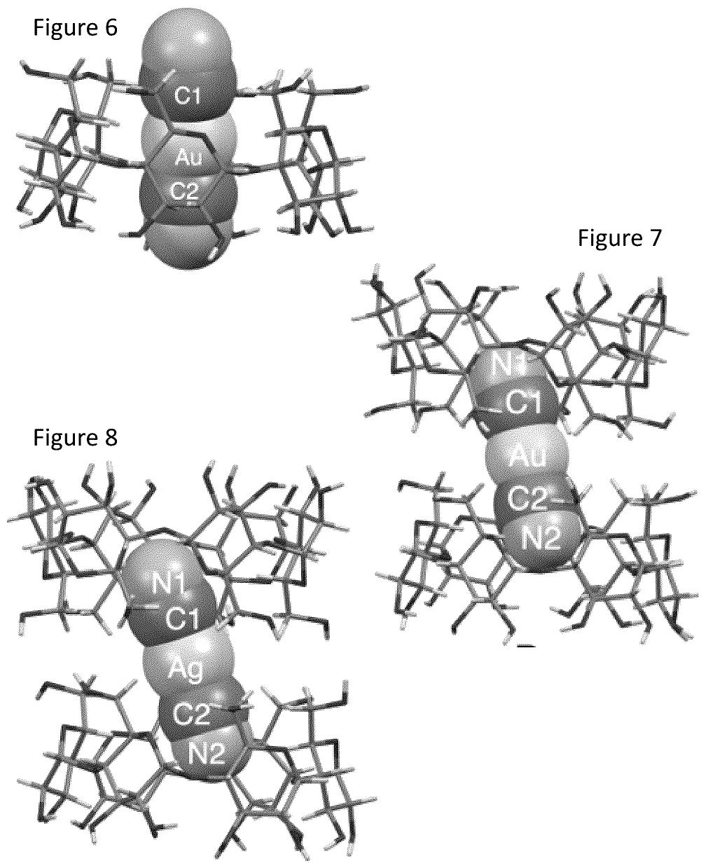

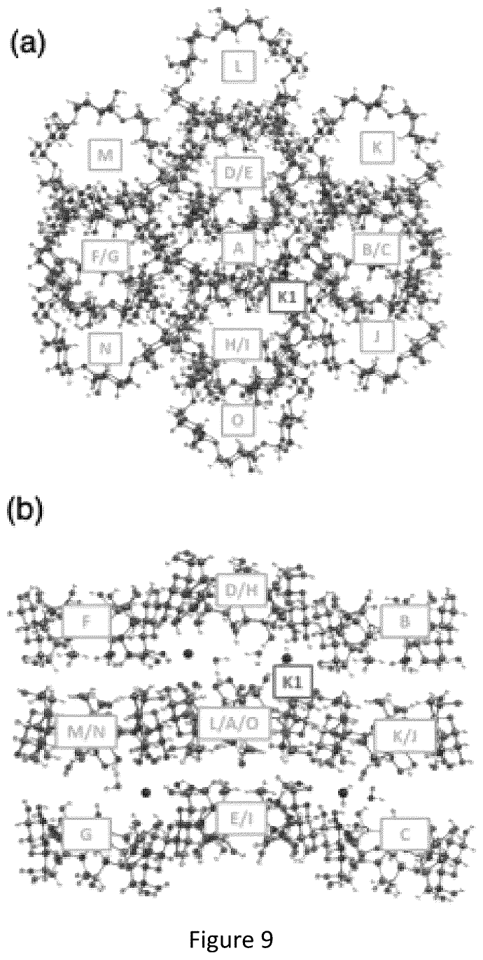

TABLE 2
Distances between Au(CN)₂_{^{−}} and the inner
protons H-3, H-5 and H-6 in each of the six glucose
subunits of α-CD. Labels are shown in FIG. 6.

| Distances Å | Unit 1 | Unit 2 | Unit 3 | Unit 4 | Unit5 | Unit 6 |
|---|---|---|---|---|---|---|
| C1-H6 | 3.7/3.8 | 3.4/3.8 | 3.9/4.6 | 5.0/5.5 | 4.8/4.6 | 3.8/3.8 |
| Au-H5 | 3.3 | 3.2 | 3.3 | 3.6 | 3.3 | 3.1 |
| C2-H3 | 4.0 | 4.3 | 3.4 | 3.1 | 3.8 | 3.8 |

### (2) Crystal Superstructure of KAu(CN)₂⊂α-CD

(a) Method: Colorless block-like single crystals were obtained by slow diffusion of EtOH into an aqueous solution (300 μL) containing KAu(CN)₂ (8.9 mg) and α-CD (30 mg) at room temperature for 14 days. A suitable crystal was selected, and the crystal was mounted on a MITIGEN holder with Paratone oil on a XtaLAB Synergy, Single source at offset/far, HyPix diffractometer. The crystal was kept at 100.0(2) K during data collection. Using Olex2^{S1}, the superstructure was solved with the XT^{S2} structure solution program using Intrinsic Phasing and refined with the XL refinement package^{S3} using Least Squares minimization.
(b) Crystal Parameters: Empirical formula=C₃₉H₇₄Au_{0.5}K_{0.5}NO₃₅, formula weight=1235.02, triclinic, space group P1̅ (no. 1), a=13.7130(5), b=13.7765(4), c=15.6190(4) Å, α=86.125(2), β=86.183(3), γ=60.219(3)°, V=2553.29(15) Å³, Z=2, T=100.0(2) K, μ(MoKα)=1.600 mm⁻¹, D_{calc}=1.606 g/mm³, 54235 reflections measured (4.214≤2Θ≤66.388), 25086 unique (Rᵢₙₜ=0.0503, R_{sigma}=0.0804) which were used in all calculations. The final R₁ was 0.0571 (I>2σ(I)) and wR₂ was 0.1383 (all data).
(c) Refinement Details: The enhanced rigid-bond restraint (SHELX keyword RIGU) was applied^{S4} on the disordered gold cyanide. The gold was partially disordered (about 3% in each site). The gold atoms were refined with a group anisotropic displacement parameter. Three reflections were omitted for being behind the beam stop.
(d) Solvent Treatment Details: N/A

TABLE 3
Distances between Au(CN)₂_{^{−}} and the inner protons
H-5 and H-6 in each of the six glucose subunits of
the two α-CDs (A and B). Labels are shown in FIG. 7.

| Distances Å | Unit 1 | Unit 2 | Unit 3 | Unit 4 | Unit5 | Unit 6 |
|---|---|---|---|---|---|---|
| C1-AH6 | 4.0/3.5 | 4.1/4.1 | 4.2/4.4 | 4.7/4.5 | 4.0/3.9 | 3.9/3.7 |
| Au-AH6 | 4.0/3.7 | 3.5/3.9 | 3.8/4.4 | 4.8/5.0 | 4.7/4.9 | 4.5/4.5 |
| N1-AH5 | 3.2 | 3.6 | 3.7 | 3.5 | 2.8 | 2.8 |
| C2-BH6 | 3.6/4.2 | 3.6/4.1 | 4.0/4.3 | 4.7/4.9 | 4.6/4.2 | 4.0/3.9 |
| Au-BH6 | 4.3/3.8 | 4.4/4.7 | 4.9/4.8 | 5.1/4.9 | 4.5/3.7 | 3.7/3.4 |
| N2-BH5 | 2.8 | 2.8 | 3.2 | 3.9 | 3.8 | 3.2 |

### (3) Crystal Superstructure of KAg(CN)₂⊂2 α-CD

Under the same conditions, we obtained the X-ray crystal superstructure of a 2:1 adduct between α-CD and KAg(CN)₂. It is worth noting that KAg(CN)₂ is a byproduct in the cyanide-based, gold-mining process. The adduct has an identical superstructure with the 2:1 adduct between α-CD and KAu(CN)₂. The two crystal superstructures are isostructural, suggesting the high similarity in superstructures and properties between these two 2:1 adducts.
(a) Method: Colorless block-like single crystals were obtained by slow diffusion of EtOH into an aqueous solution (300 μL) containing KAg(CN)₂ (6.2 mg) and α-CD (30 mg) at room temperature during 14 days. A suitable crystal was selected, and the crystal was mounted on a MITIGEN holder with Paratone oil on a XtaLAB Synergy, Single source at offset/far, HyPix diffractometer. The crystal was kept at 99.98(17) K during data collection. Using Olex2^{S1}, the superstructure was solved with the XT^{S2} structure solution program using Intrinsic Phasing and refined with the XL refinement package^{S3} using Least Squares minimization.
(b) Crystal Parameters: Empirical formula=C₇₈H₁₄₈AgKN₂O₇₀, formula weight=2380.95, triclinic, space group P1̅ (no. 1), a=13.7332(5), b=13.7848(5), c=15.6408(7) Å, α=86.135(4), β=86.215(3), γ=60.269(4)°, V=2563.54(19) Å³, Z=1, T=99.98(17) K, μ(MoKα)=0.356 mm⁻¹, D_{calc}=1.542 g/mm³, 17511 reflections measured (4.15≤2Θ≤59.436), 12082 unique (Rᵢₙₜ=0.0362, R_{sigma}=0.0527) which were used in all calculations. The final R₁ was 0.0755 (I>2σ(I)) and wR₂ was 0.1988 (all data).
(c) Refinement Details: The enhanced rigid-bond restraint (SHELX keyword RIGU) was applied^{S4} on the disordered silver cyanide. The silver atoms were partially disordered (about 4% in each site). The silver atoms were refined with a group anisotropic displacement parameter. C31 was refined so that its displacement parameter was approximate isotropic.
(d) Solvent Treatment Details: N/A

TABLE 4
Distances between Ag(CN)₂_{^{−}} and the inner protons
H-5 and H-6 in each of the six glucose subunits of
the two α-CDs (A and B), labels are shown in FIG. 8.

| Distances Å | Unit 1 | Unit 2 | Unit 3 | Unit 4 | Unit5 | Unit 6 |
|---|---|---|---|---|---|---|
| C1-AH6 | 4.0/3.6 | 4.1/4.2 | 4.2/4.4 | 4.6/4.4 | 4.0/3.9 | 3.9/3.6 |
| Ag-AH6 | 4.1/3.7 | 3.5/3.9 | 3.8/4.4 | 4.8/5.1 | 4.7/4.9 | 4.6/ 4.5 |
| N1-AH5 | 3.1 | 3.6 | 3.8 | 3.5 | 2.8 | 2.8 |
| C2-BH6 | 3.5/4.1 | 3.5/3.9 | 4.0/4.2 | 4.7/5.0 | 4.7/4.4 | 4.0/4.0 |
| Ag-BH6 | 4.3/3.8 | 4.4/4.5 | 4.9/4.7 | 5.1/4.9 | 4.5/3.7 | 3.7/3.4 |
| N2-BH5 | 2.7 | 2.8 | 3.3 | 3.9 | 3.8 | 3.2 |

### Computational Investigations

### Visualization of Noncovalent Interactions

Independent Gradient Model (IGM) analysis is an approach^{S5} based on promolecular density (an electron density model prior to molecule formation) to identify and isolate intermolecular interactions. Strong polar attractions and van der Waals contacts are visualized as an iso-surface with blue and green color, respectively. Single crystal superstructures were used as input files. The binding surface was calculated by Multiwfn 3.6 program^{S6} through function 20 (visual study of weak interaction) and visualized by Chimera software.^{S7}

### Binding Energy Analysis

The xyz coordinates for the single-point calculations were extracted from the X-ray single crystal data. All optimizations and single-point calculations were performed with density functional theory (DFT) in the Orca program^{S8} (version 4.1.2) using the Coulomb attenuated method (range-corrected) and hybrid Becke three-parameter Lee-Yang-Parr^{S9} (CAM-B3LYP) functional, the Ahlrich's double zeta basis set with a polarization function^{S10} Def2-SVP, and Grimme's third-generation dispersion with Beck Johnson damping (D3BJ). In order to speed up the DFT optimizations, the Coulomb integral and numerical chain-of-sphere integration for the HF exchanges^{S11,S12} (RIJCOSX) method was applied with the Def2/J auxiliary basiss^{S13} (AuxJ). The optimizations in a water continuum were performed with the Conductor like Polarizable Continuum Model^{S14} (CPCM) in Orca.

TABLE 5
Binding energies for optimizations in vacuum of (1:1) structures

| | Electronic | Binding Energy |
|---|---|---|
| Entry | Energy (DFT) | (kcal mol⁻¹) |
| α-CD | −3660.606331 | NA |
| Ag(CN)₂⁻ | −332.4985083 | NA |
| Au(CN)₂⁻ | −321.2813003 | NA |
| α-CD-Ag(CN)₂⁻ | −3993.162487 | −36.17 |
| α-CD-Au(CN)₂⁻ | −3981.944433 | −35.64 |

TABLE 6
Binding energies for optimizations in
water continuum of (1:1) structures

| | Electronic | Binding Energy |
|---|---|---|
| Entry | Energy (DFT) | (kcal mol⁻¹) |
| α-CD | −3660.647251 | NA |
| Ag(CN)₂⁻ | −332.5811008 | NA |
| Au(CN)₂⁻ | −321.3620598 | NA |
| α-CD-Ag(CN)₂⁻ | −3993.286396 | −36.42 |
| α-CD-Au(CN)₂⁻ | −3982.061353 | −32.66 |

TABLE 7
Binding energies for (1:1) single crystal with Au(CN)₂⁻

| | Electronic | Binding Energy |
|---|---|---|
| Entry | Energy (DFT) | (kcal mol⁻¹) |
| Au(CN)₂⁻ | −321.2455053 | NA |
| K1⁺ | −599.6908053 | NA |
| A | −3659.75888 | NA |
| B | −3659.785735 | NA |
| C | −3659.808142 | NA |
| D | −3659.808339 | NA |
| E | −3659.785714 | NA |
| F | −3659.785733 | NA |
| G | −3659.808142 | NA |
| H | −3659.808266 | NA |
| I | −3659.785768 | NA |
| J | −3659.758687 | NA |
| K | −3659.758802 | NA |
| L | −3659.758991 | NA |
| M | −3659.758801 | NA |
| N | −3659.758686 | NA |
| O | −3659.758897 | NA |
| A . . . B | −7319.57024 | −16.08 |
| A . . . C | −7319.567617 | −0.37 |
| A . . . D | −7319.57169 | −2.81 |
| A . . . E | −7319.561925 | −10.88 |
| A . . . F | −7319.554659 | −6.30 |
| A . . . G | −7319.567688 | −0.42 |
| A . . . H | −7319.569673 | −1.59 |
| A . . . I | −7319.56282 | −11.40 |
| A . . . J | −7319.538412 | −13.08 |
| A . . . K | −7319.53853 | −13.08 |
| A . . . L | −7319.533808 | −10.00 |
| A . . . M | −7319.557437 | −24.95 |
| A . . . N | −7319.557323 | −24.95 |
| A . . . O | −7319.533714 | −10.00 |
| A . . . Au(CN)₂⁻ | −3981.055943 | −32.35 |
| (H₂O)₂ (α-CD_{AHB})₃ | −11132.05969 | NA |
| K1⁺ (H₂O)₂ | −11731.93202 | −113.91 |
| (α-CD_{AHB})₃ | | |

The binding analysis of [α-CD . . . α-CD] interaction is illustrated below. The excess of free water molecules around the cyclodextrins and not bound to K⁺ ions were removed. Only one potassium ion (labeled K1⁺) was selected to reduce computational cost.

TABLE 8
Selected binding energies for (1:2)
single crystal adduct with Au(CN)₂⁻

| | Electronic | Binding Energy |
|---|---|---|
| Entry | Energy (DFT) | (kcal mol⁻¹) |
| α-CD (left side edge-to-edge) | −3659.805069 | NA |
| α-CD (right side edge-to-edge) | −7319.650896 | −25.57 |
| α-CD . . . α-CD (edge-to-edge) | −3659.786144 | NA |
| α-CD . . . α-CD (edge-to-edge) | −7319.675058 | −52.61 |
| Au(CN)₂⁻ | −321.278387 | NA |
| α-CD | −3659.786129 | NA |
| Au(CN)₂⁻ . . . α-CD | −3981.13207 | −42.39 |
| α-CD . . . EtOH | −3814.569737 | NA |
| Au(CN)₂⁻ . . . α-CD . . . EtOH | −4135.948188 | −62.79 |
| (α-CD)₂ | −7319.591187 | NA |
| Au(CN)₂⁻ . . . (α-CD)₂ | −7640.996099 | −79.39 |
| (α-CD)₂ . . . (EtOH)₂ | −7629.166154 | NA |
| Au(CN)₂⁻ . . . (α-CD)₂ . . . (EtOH)₂ | −7950.635384 | −119.75 |

TABLE 9
Selected binding energies for (1:1)
single crystal adduct with Ag(CN)₂⁻

| | Electronic | Binding Energy |
|---|---|---|
| Entry | Energy (DFT) | (kcal mol⁻¹) |
| Ag(CN)₂⁻ | −332.4620557 | NA |
| A | −3659.75888 | NA |
| A . . . Ag(CN)₂⁻ | −3992.270807 | −31.29 |

TABLE 10
Selected binding energies for (1:2)
single crystal adduct with Ag(CN)₂⁻.

| | Electronic | Binding Energy |
|---|---|---|
| Entry | Energy (DFT) | (kcal mol⁻¹) |
| Ag(CN)₂⁻ | −332.493334 | NA |
| α-CD | −3659.780104 | NA |
| Ag(CN)₂⁻ . . . α-CD | −3992.323065 | −31.14 |
| EtOH | −154.7830196 | NA |
| Ag(CN)₂⁻ . . . α-CD . . . EtOH | −4147.136268 | −50.08 |
| (α-CD)₂ | −7319.534601 | NA |
| Ag(CN)₂⁻ . . . (α-CD)₂ | −7652.147928 | −75.30 |
| (α-CD)₂ . . . (EtOH)₂ | −7629.105661 | NA |
| Ag(CN)₂⁻ . . . (α-CD)₂ . . . (EtOH)₂ | −7961.779314 | −113.15 |

### Binding Studies Using NMR Spectroscopy

¹H NMR Titration experiments in D₂O were performed at 25° C. Aliquots from a stock solution containing the appropriate KAu(CN)₂ were added sequentially to an NMR tube containing the cyclodextrins, and a ¹H NMR spectrum was acquired after each addition. The titration isotherms were fitted to either 1:1 or 1:2 receptor-substrate binding model using Thordarson's equations^{S15} at http://app.supramolecular.org/bindfit/. All the titrations were independently duplicated (shown below is one set of titration isotherms) and all isotherm fittings were used to calculate the average Kₐ with standard errors.

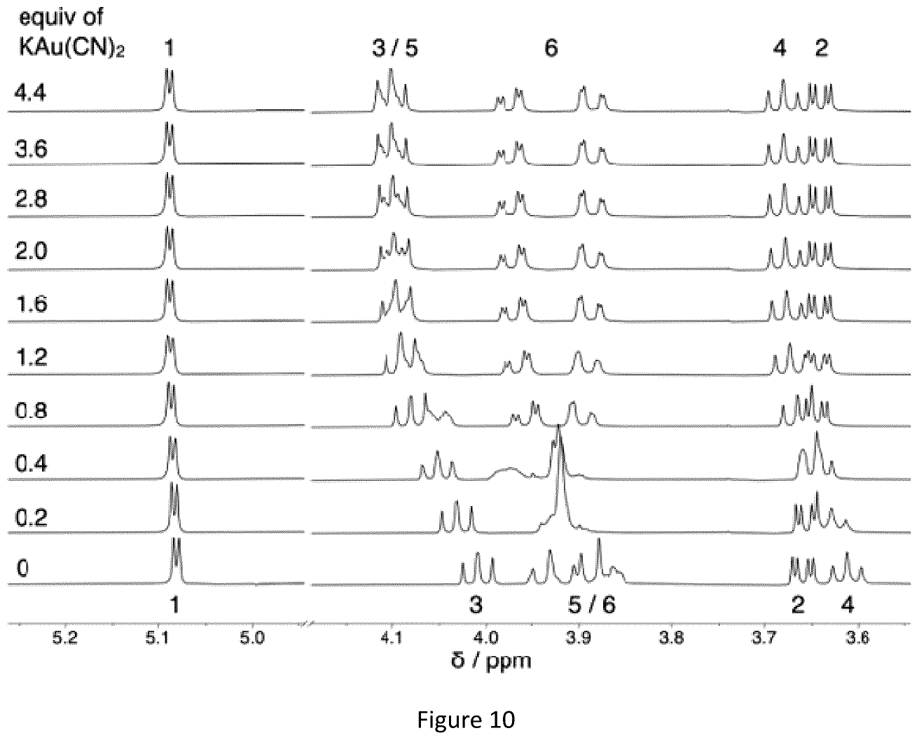

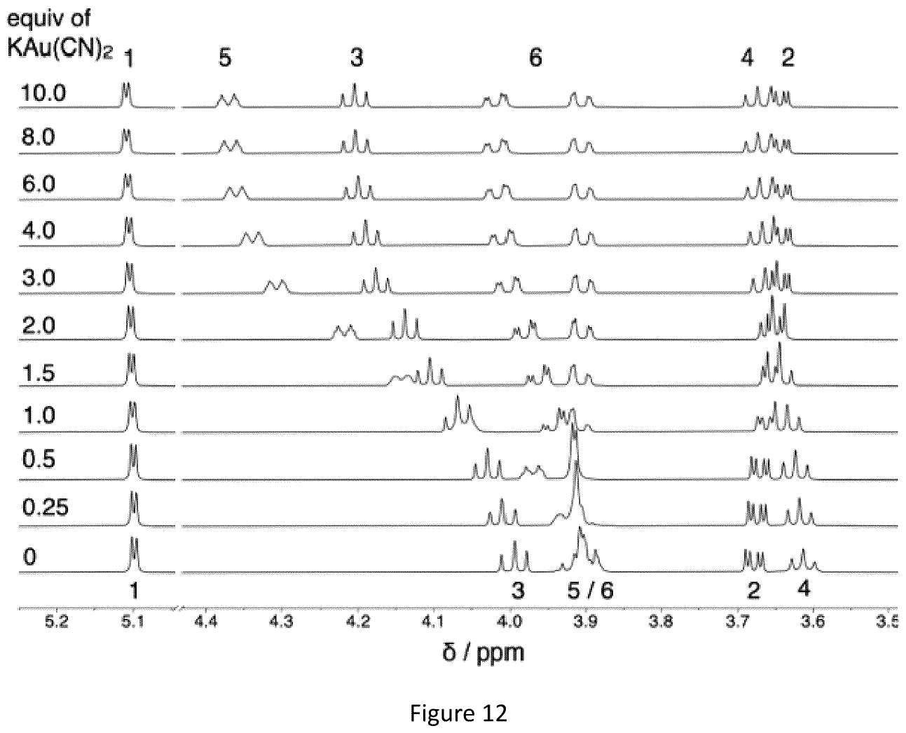

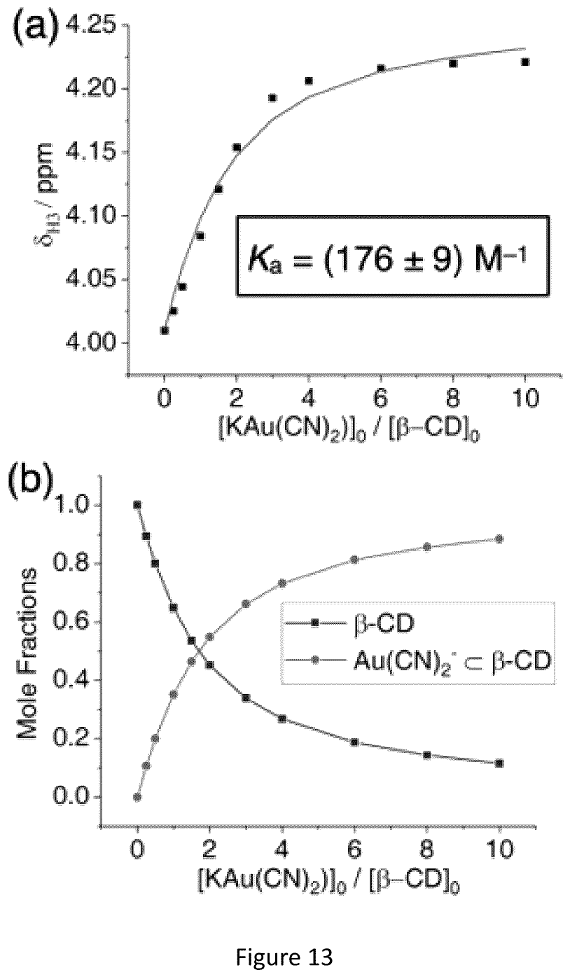

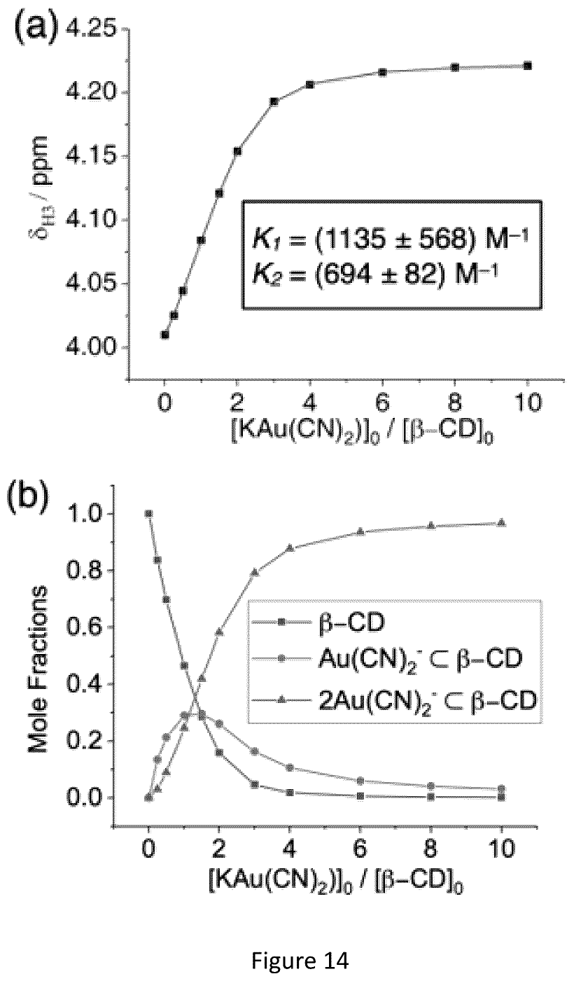

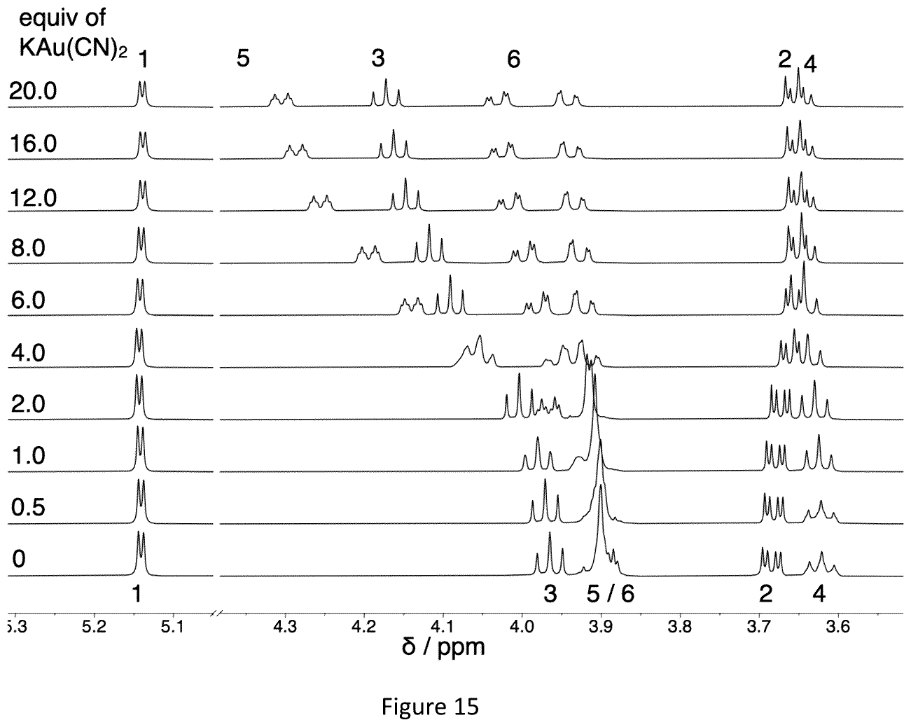

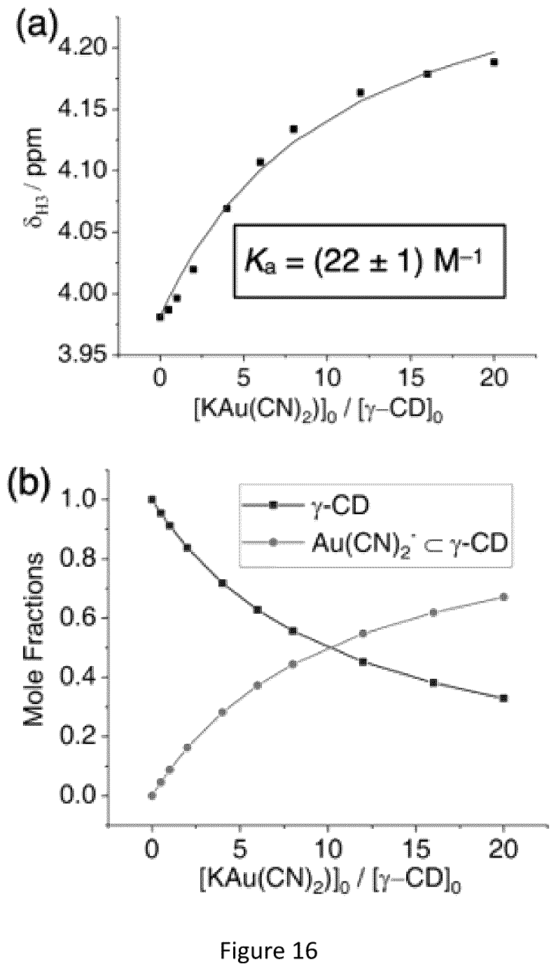

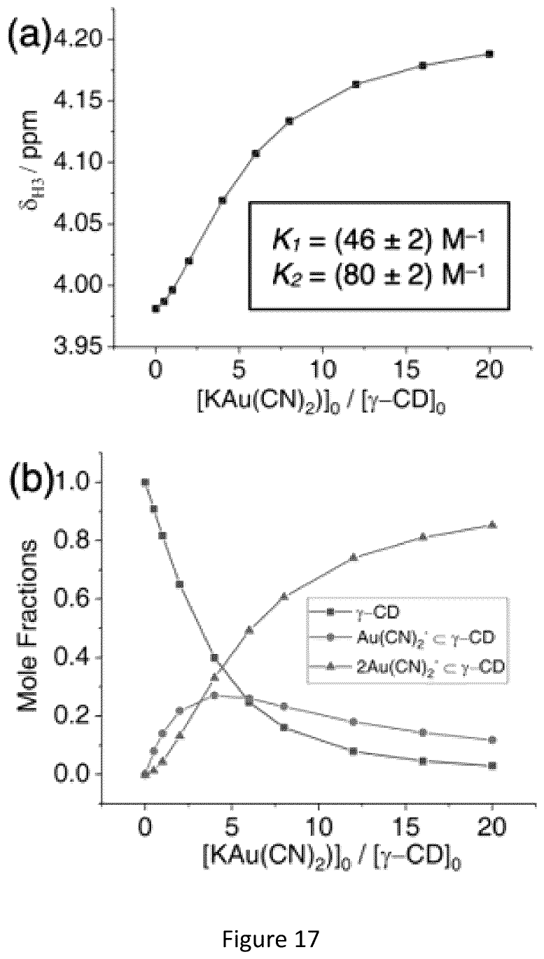

The titrations for β- and γ-CD using Au(CN)₂⁻ reveal (FIGS. 10-14) much weaker binding affinities in D₂O with Kₐ values in the order of 10² and 10¹ M⁻¹, respectively. It is worth noting that the titration data for β- and γ-CD fit poorly using a 1:1 binding model. A 1:2 binding model between the larger CDs and Au(CN)₂⁻ leads to a better fit, suggesting that these larger CDs can encapsulate two Au(CN)₂⁻ ions in D₂O.

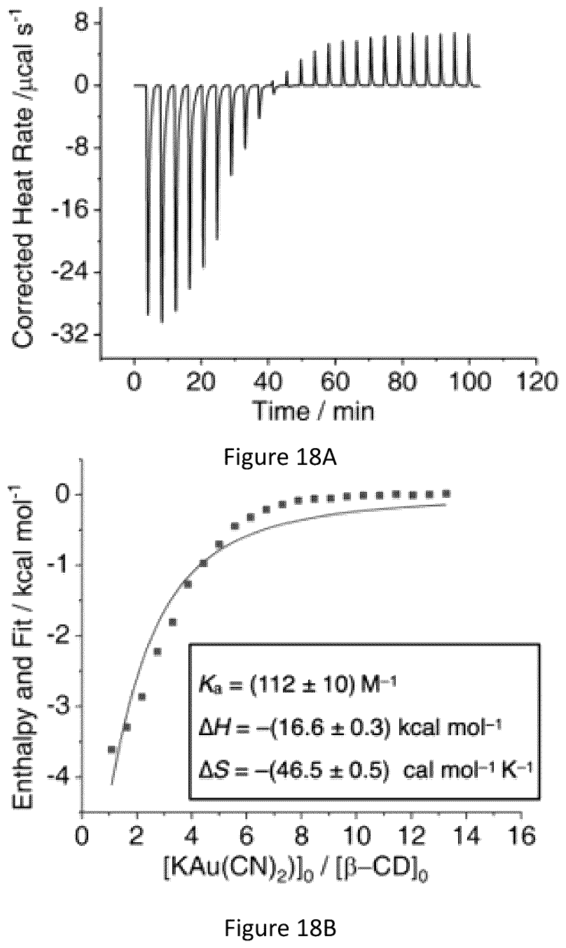

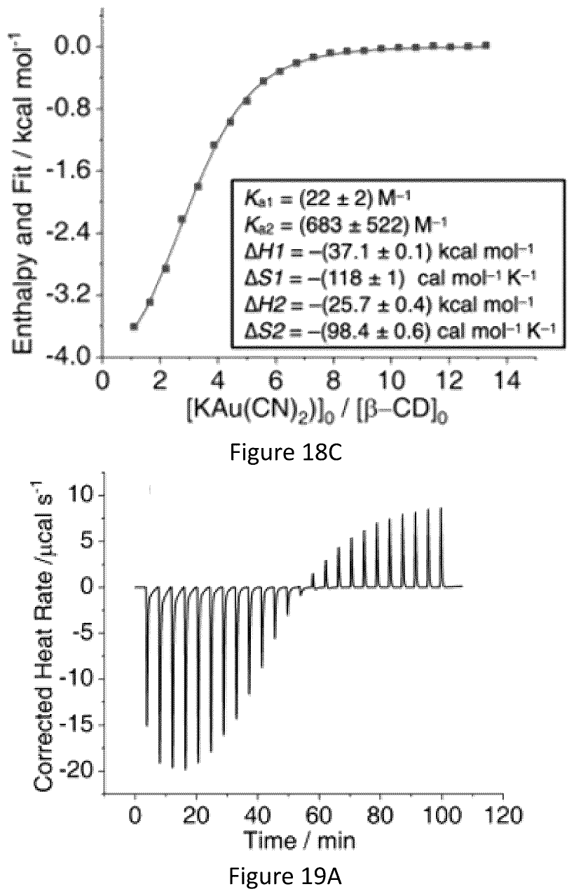

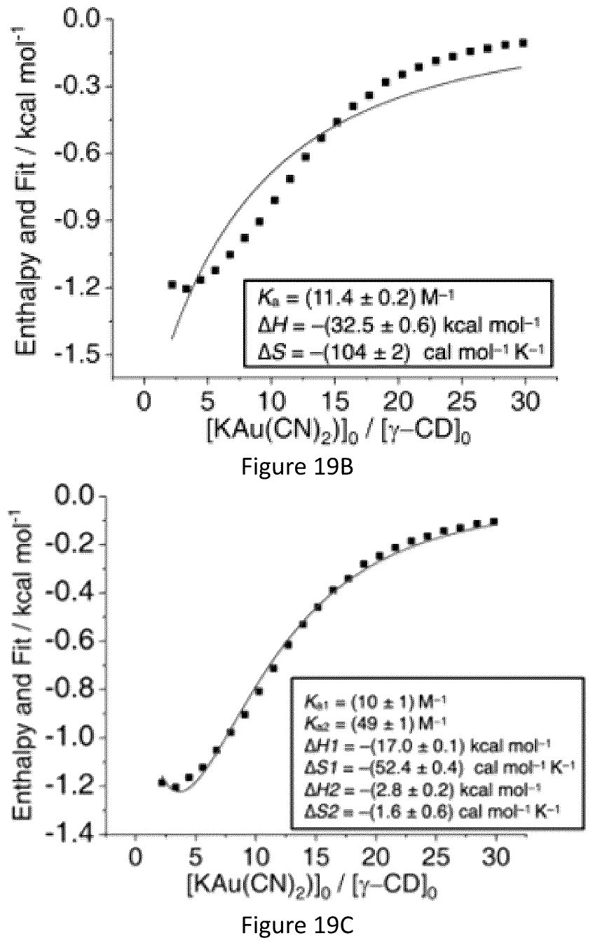

2:1 Binding models were used for the data fitting, resulting in Kₐ values in the order of 10² and 10¹ M⁻¹ for β- and γ-CD, respectively, matching the results obtained from ¹H NMR titration experiments. The binding affinities of KAu(CN)₂ with β- and γ-CD are much weaker and fit poorly to isotherms employing (FIGS. 18-19) 1:1 binding models.

### Binding Studies Using Isothermal Titration Calorimetry

Isothermal titration calorimetry (ITC) was performed by TA Nano Isothermal Titration calorimeter at 25° C. A Hastelloy cell was used with an active cell volume of 190 μL. The stirring speed was set at 75 rpm. Receptor and substrate solutions were prepared in Milli-Q water and allowed to equilibrate overnight if necessary. In each titration experiment, 20-25 injections were performed with gradually decreased titration peaks until saturation is reached, at which point only heat of dilution was measured. The heat of dilution, when using γ-CD, was directly measured by titrating KAu(CN)₂ into a blank solution. After subtracting the heat of dilution, the resulting data were analyzed with NanoAnalyze software using either a 1:1 or a 1:2 receptor-substrate binding model and plotted by Origin Lab 8.6 software. All the titrations were independently duplicated. Shown below is one set of titration isotherms. All isotherm fittings were used to calculate the average Kₐ and ΔH with relevant standard errors.

### Gold and Silver Stripping

### Gold Adsorption on Activated Carbon

Activated carbon (10 g) was added to an aqueous solution (50 mL) of KAu(CN)₂ (150 mg, Au concentration: 2041 ppm), and the suspension was stirred at room temperature for 3 days. The activated carbon was filtrated and dried over the oven at 110° C. overnight. The remaining gold in the filtrate was analyzed by ICP, which revealed that the concentration of gold is less than 3 ppm, suggesting quantitative adsorption of Au on activated carbon. The activated carbon had a weight loss of 15% after drying under the same conditions, indicating 102 mg Au was adsorbed on 8.5 g activated carbon. The gold loading on activated carbon was thus calculated to be 12 mg/g.

### Silver Adsorption on Activated Carbon

Activated carbon (10 g) was added to an aqueous solution (50 mL) of KAg(CN)₂ (150 mg, Ag concentration: 1613 ppm), and the suspension was stirred at room temperature for 3 days. The activated carbon was filtrated and dried in an oven at 110° C. overnight. The remaining gold in the filtrate was analyzed by ICP, which revealed that the concentration of gold is less than 3 ppm, suggesting quantitative adsorption of Ag on activated carbon. The activated carbon had a weight loss of 15% after drying under the same conditions, indicating 88 mg Ag was adsorbed on 8.5 g activated carbon. The silver loading on activated carbon was estimated to be 10 mg/g.

### Gold and Silver Adsorption on Activated Carbon

Activated carbon (10 g) was added to an aqueous solution (50 mL) of KAu(CN)₂ (150 mg, Au concentration: 2041 ppm) and KAg(CN)₂ (150 mg, Ag concentration: 1613 ppm), and the suspension was stirred at room temperature for three days. The activated carbon was filtrated and dried in an oven at 110° C. overnight. The remaining gold and silver in the filtrate were analyzed by ICP, which revealed that the concentrations of gold and silver are less than 3 ppm, suggesting quantitative adsorption of Au and Ag on activated carbon. The activated carbon had a weight loss of 15% after drying under the same conditions, indicating 102 mg Au and 88 mg Ag were adsorbed on 8.5 g activated carbon. The gold and silver loading on activated carbon was estimated to be 12 and 10 mg/g, respectively.

### Gold and/or Silver Stripping

Metal loaded activated carbon (50 mg, containing either 0.6 mg Au or 0.5 mg Ag) was added to an aqueous solution (5 mL) of α-CD (0-10 w/v %, heat is applied to dissolve α-CD when its concentration is >2% w/v %). The suspension was stirred for 30 min at room temperature, after which the activated carbon was separated by centrifuge. The supernatant was filtrated by a 0.45 μm syringe filter, and the concentration of Au and Ag was analyzed by inductively coupled plasma mass spectrometry (ICP-MS). Each experiment was duplicated independently, and the average concentrations were presented with standard deviations. The same protocols were performed for gold stripping using γ-CD and selective gold string from the activated carbon loaded with both gold and silver.

### ICP-MS Analysis

Quantification of gold (Au) and silver (Ag) was accomplished using ICP-MS of acidified samples. Specifically, samples (100 μL) designated for Au analysis were digested in concentrated HNO₃ (200 uL, 69%, Thermo Fisher Scientific, Waltham, MA, USA) and concentrated HCl (200 uL, 34%, Thermo Fisher Scientific, Waltham, MA, USA) at room temperature for 10 min in a ventilated hood. Cyanide test strips were used to ensure that no cyanide gas was evolving after this time, and ultra-pure H₂O (18.2 MΩ·cm) was added to produce a final solution of 2.0% HNO₃ and 2.0% HCl (v/v) in a total sample volume of 10 mL. A quantitative standard was made using a 100 μg/mL Au elemental standard (Inorganic Ventures, Christiansburg, VA, USA), which was used to create a 100 ng/g Au standard in 2.0% HNO₃ and 2.0% HCl (v/v) in a total sample volume of 50 mL. A solution of 2.0% HNO₃ and 2.0% HCl (v/v) was used as the calibration blank.

Samples designated for Ag analysis were digested in 200 uL concentrated trace nitric acid (>69%, Thermo Fisher Scientific, Waltham, MA, USA) at room temperature for 10 min in a ventilated hood. Cyanide test strips were used to ensure that no cyanide gas was evolving after this time, and ultra-pure H₂O (18.2 MΩ·cm) was added to produce a final solution of 2.0% HNO₃ in a total sample volume of 10 mL. A quantitative standard was made using a 100 μg/mL Ag elemental standard (Inorganic Ventures, Christiansburg, VA, USA), which was used to create a 100 ng/g Ag standard in 2.0% nitric acid in a total sample volume of 50 mL. A solution of 2.0% nitric acid was used as the calibration blank.

ICP-MS was performed on a computer-controlled (QTEGRA software) Thermo iCapQ ICP-MS (Thermo Fisher Scientific, Waltham, MA, USA) operating in STD mode and equipped with an ESI SC-2DX PrepFAST autosampler (Omaha, NE, USA). The internal standard was added inline using the prepFAST system and consisted of 1 ng/ml of a mixed element solution containing Bi, In, ⁶Li, Sc, Tb, Y (IV-ICPMS-71D from Inorganic Ventures). Online dilution was also carried out by the prepFAST system and used to generate a calibration curve consisting of 100, 50, 10, 2 and 1 ppb Au or Ag. Each sample was acquired using 1 survey run (10 sweeps) and 3 main (peak jumping) runs (40 sweeps). The isotopes selected for analysis were ^{107,109}Ag or ¹⁹⁷Au and ⁸⁹Y, ¹¹⁵In, ¹⁵⁹Tb, ²⁰⁹Bi (chosen as internal standards for data interpolation and machine stability). Instrument performance is optimized daily through autotuning, followed by verification via a performance report (passing manufacturer specifications).

### General Information

Commercially available solvents and chemicals were purchased from Sigma-Aldrich and Fisher Scientific and used without further purification unless otherwise stated. Nuclear magnetic resonance (NMR) spectra were recorded on a Bruker AVANCE III 600 MHz spectrometer. Chemical shifts are reported in ppm relative to the signals corresponding to the residual non-deuterated solvents. Single crystal data were obtained on a XtaLAB Synergy, Single source at offset/far, HyPix diffractometer. ICP-MS was performed on a computer-controlled (QTEGRA software) Thermo iCapQ ICP-MS (Thermo Fisher Scientific, Waltham, MA, USA) operating in STD mode and equipped with an ESI SC-2DX PrepFAST autosampler (Omaha, NE, USA). Detailed experimental procedures are provided in the appropriate sections that follow this one. Activated carbon (Part number: 05105, Lot code: 1136095) were purchased from Fluka with the following specifications (Table 11):

TABLE 11
Specifications of the activated carbon.

| | | | |
|---|---|---|---|
| Loss on drying (110° C.) | <15% | Co | <0.001% |
| Ash (600° C.) | <0.1% | Cr | <0.001% |
| Iodine-adsorption | >70 ml/g | Cu | <0.001% |
| (0.05 mol I₂/I) | | | |
| Methylene blue- | >12 ml/0.1 g | Fe | <0.03% |
| adsorption (0.15% sol.) | | | |
| Soluble material in | <0.2% | K | <0.02% |
| ethanol | | | |
| Soluble material in HCl | <1% | Mg | <0.02% |
| Water-soluble matter | <0.5% | Mn | <0.005% |
| Chloride (Cl) | <0.5% | Na | <0.05% |
| Sulfate (SO₄) | <0.5% | Ni | <0.001% |
| Ca | <0.1% | Pb | <0.001% |
| Cd | <0.001% | Zn | <0.001% |

### REFERENCES

(S1) Dolomanov, O. V; Bourhis, L. J.; Gildea, R. J.; Howard, J. A. K.; Puschmann, H. OLEX2: A Complete Structure Solution, Refinement and Analysis Program. J. Appl. Crystallogr. 2009, 42, 339-341.
(S2) Sheldrick, G. M. SHELXT-Integrated Space-Group and Crystal-Structure Determination. Acta Crystallogr. Sect. A 2015, 71, 3-8.
(S3) Sheldrick, G. M. A Short History of SHELX. Acta Crystallogr. Sect. A 2008, 64, 112-122.
(S4) Thorn, A.; Dittrich, B.; Sheldrick, G. M. Enhanced Rigid-Bond Restraints. Acta Crystallogr. Sect. A 2012, 68, 448-451.
(S5) Lefebvre, C.; Rubez, G.; Khartabil, H.; Boisson, J. C.; Contreras-García, J.; Hénon, E. Accurately Extracting The Signature of Intermolecular Interactions Present in The NCI Plot of The Reduced Density Gradient Versus Electron Density. Phys. Chem. Chem. Phys. 2017, 19, 17928-17936.
(S6) Lu, T.; Chen, F. Multiwfn: A Multifunctional Wavefunction Analyzer. J. Comput. Chem. 2012, 33, 580-592.
(S7) Pettersen, E. F.; Goddard, T. D.; Huang, C. C.; Couch, G. S.; Greenblatt, D. M.; Meng, E. C.; Ferrin, T. E. UCSF Chimera—A Visualization System for Exploratory Research and Analysis. J. Comput. Chem. 2004, 25, 1605-1612.
(S8) Neese, F. The ORCA Program System. WIREs Comput. Mol. Sci. 2012, 2, 73-78.
(S9) Becke, A. D. Density-functional Thermochemistry. III. The Role of Exact Exchange. J. Chem. Phys. 1993, 98, 5648-5652.
(S10) Weigend, F.; Ahlrichs, R. Balanced Basis Sets of Split Valence{,} Triple Zeta Valence and Quadruple Zeta Valence Quality for H to Rn: Design and Assessment of Accuracy. Phys. Chem. Chem. Phys. 2005, 7, 3297-3305.
(S11) Neese, F. An Improvement of the Resolution of the Identity Approximation for the Formation of the Coulomb Matrix. J. Comput. Chem. 2003, 24, 1740-1747.
(S12) Izsák, R.; Neese, F. An Overlap Fitted Chain of Spheres Exchange Method. J. Chem. Phys. 2011, 135, 144105.
(S13) Stoychev, G. L.; Auer, A. A.; Neese, F. Automatic Generation of Auxiliary Basis Sets. J. Chem. Theory Comput. 2017, 13, 554-562.
(S14) Barone, V.; Cossi, M. Quantum Calculation of Molecular Energies and Energy Gradients in Solution by a Conductor Solvent Model. J. Phys. Chem. A 1998, 102, 1995-2001.
(S15) Thordarson, P. Determining Association Constants from Titration Experiments in Supramolecular Chemistry. Chem. Soc. Rev. 2011, 40, 1305-1323.

1. A composition comprising a surface-bound, linear gold anion and a solution, the solution comprising a molecular receptor.

2. The composition of claim 1, wherein the molecular receptor is α-cyclodextrin (α-CD).

3. The composition of claim 1, wherein the linear gold anion is Au(CN)₂⁻.

4. The composition of claim 1, wherein the composition comprises an adduct formed from the molecular receptor and the linear gold anion.

5. The composition of claim 1, wherein the surface is the surface of activated carbon.

6. The composition of claim 1, wherein the solution is an aqueous solution

7. The composition of claim 1, wherein the solution comprising the molecular receptor at a concentration of 1-10 w/v %.

8. A method for gold stripping, the method comprising contacting a surface-bound, linear gold anion with a solution comprising a molecular receptor under conditions sufficient for transferring the linear gold anion from the surface into the solution.

9. The method of claim 8, wherein the surface-bound linear gold anion is contacted with the solution comprising the molecular receptor in the presence of a surface-bound contaminant and the linear gold-anion is selectively transferred from the surface into the solution.

10. The method of claim 8, wherein the linear gold anion is Au(CN)₂⁻.

11. The method of claim 10, wherein the contaminant is Ag(CN)₂⁻.

12. The method of claim 8, wherein the molecular receptor is α-cyclodextrin (α-CD).

13. The method of claim 8, wherein solution comprises an adduct formed from the molecular receptor and the linear gold anion.

14. The method of claim 8, wherein the surface is the surface of activated carbon.

15. The method of claim 8, wherein the solution is an aqueous solution.

16. The method of claim 8, wherein the solution comprising the molecular receptor at a concentration of 1-10 w/v %.

17. The method of claim 8, wherein the linear gold anion is transferred from the surface into the solution at a temperature between about 10° C. and about 40° C.

18. The method of claim 8 further comprising recovering gold from the solution.

19. The method of claim 18, wherein the gold is recovered electrolytically.

20. An electrolytic system comprising an electrode and an electrolyte comprising a molecular receptor and a linear gold anion.

21. (canceled)
